(19) United States
(12) Patent Application Publication
(10) Pub. No.: US 2024/0271942 A1
(43) Pub. Date: Aug. 15, 2024

(54) ROUTE DETERMINATION SYSTEM AVD ROUTE DETERMINATION METHOD

(71) Applicant: SoftBank Corp., Tokyo (JP)

(72) Inventors: Kunimitsu ASANUMA, Minato, Tokyo (JP); Akitoshi SHIMADA, Minato, Tokyo (JP); Suguru YASURAOKA, Minato, Tokyo (JP)

(73) Assignee: SoftBank Corp., Tokyo (JP)

(21) Appl. No.: 18/022,563

(22) PCT Filed: Dec. 1, 2022
(86) PCT No.: PCT/JP2022/044468

§ 371 Date: Feb. 22, 2023

(30) Foreign Application Priority Data
Dec. 22, 2021 (JP) 2021-208569

(51) Int. Cl. G01C 21/20; G01S 19/40; G01S 19/43

(52) U.S. Cl. CPC G01C 21/20; G01S 19/40; G01S 19/43

(57) ABSTRACT

A route determination system according to the present application includes: a terminal device serving as a reference of a route for a mobile object; and a determination apparatus. The terminal device has an obtaining unit that obtains correction information generated on the basis of data received from an artificial satellite, and a calculation unit that calculates position information on the terminal device on the basis of the correction information obtained by the obtaining unit. The determination apparatus has a determination unit that determines a movement route for a mobile object on the basis of the position information calculated by the calculation unit.

### FIELD

The present invention relates to route determination systems, route determination methods, and system programs.

### BACKGROUND

There has recently been an increasing need for position determination that is highly accurate.

For example, a so-called automobile navigation assistance technique has been proposed in Patent Literature 1, the technique allowing a mobile object (an automobile) to autonomously travel a path retrieved by a search for a route matching user conditions, the search being based on position information obtained by the Real Time Kinematic (RTK).

### CITATION LIST

### Patent Literature

Patent Literature 1: Japanese Unexamined Patent Application Publication No. 2019-190975

### SUMMARY

### Technical Problem

There is a demand for improved usability in route setting for mobile objects.

### Solution to Problem

A route determination system including: terminal devices serving as references for a route of a mobile object and a determination apparatus, wherein the terminal devices has an obtainment unit that obtains correction information generated on the basis of data received from an artificial satellite and a calculation unit that calculates position information on the terminal device on the basis of the correction information obtained by the obtainment unit, and the determination apparatus has a determination unit that determines a movement route for the mobile object on the basis of the position information calculated by the calculation unit.

### Advantageous Effects of Invention

According to one aspect of an embodiment, for example, an effect is achieved, the effect enabling improved usability in route setting for mobile objects.

### BRIEF DESCRIPTION OF DRAWINGS

FIG. 1 is a diagram illustrating an example of a route determination system according to an embodiment.

FIG. 2 is a first diagram illustrating an overview of a route determination process according to an embodiment.

FIG. 3 is a second diagram illustrating an overview of a route determination process according to an embodiment.

FIG. 4 is a diagram illustrating an example of a configuration of a terminal device according to an embodiment.

FIG. 5 is a diagram illustrating an example of a configuration of a calculation apparatus according to the embodiment.

FIG. 6 is a diagram illustrating an example of a configuration of a determination apparatus according to the embodiment.

FIG. 7 is a diagram illustrating an example of a configuration of a mobile device according to the embodiment.

FIG. 8 is a first diagram illustrating an example of a route determination process according to a first embodiment.

FIG. 9 is a second diagram illustrating an example of the route determination process according to the first embodiment.

FIG. 10 is a first diagram illustrating an example of a route determination process according to a second embodiment.

FIG. 11 is a second diagram illustrating an example of the route determination process according to the second embodiment.

FIG. 12 is a third diagram illustrating an example of the route determination process according to the second embodiment.

FIG. 13 is a fourth diagram illustrating an example of the route determination process according to the second embodiment.

FIG. 14 is a fifth diagram illustrating an example of the route determination process according to the second embodiment.

FIG. 15 is a sixth diagram illustrating an example of the route determination process according to the second embodiment.

FIG. 16 is a seventh diagram illustrating an example of the route determination process according to the second embodiment.

FIG. 17 is an eighth diagram illustrating an example of the route determination process according to the second embodiment.

FIG. 18 is a ninth diagram illustrating an example of the route determination process according to the second embodiment.

FIG. 19 is a tenth diagram illustrating an example of the route determination process according to the second embodiment.

FIG. 20 is a hardware configuration diagram illustrating an example of a computer that implements functions of a determination apparatus.

### DESCRIPTION OF EMBODIMENTS

One mode (hereinafter, referred to as the ‘embodiment’) for implementing a route determination system, a route determination method, and a system program according to the present application will hereinafter be described while reference is made, as appropriate, to the drawings. This embodiment does not limit the route determination system, route determination method, and system program according to the present application. Furthermore, in the following embodiment, the same reference sign will be assigned to parts that are the same and redundant description thereof will be omitted. Furthermore, in the following description, obtainment of position information by calculation, for example, may be referred to as ‘position determination’.

### Outline Common to Embodiments

### 1. Introduction

In many fields, solutions and provision of services are hoped for, the solutions and the provision of services both utilizing position information on various mobile objects, such as drones, construction machines, agricultural machines, automobiles, marine vessels, and aircrafts. For example, areas of application of drones have been extending to industrial purposes and commercial purposes, such as inspection of roofs and walls, solar panels, and power transmission lines, without being limited to mere aerophotographic purposes. Furthermore, drones have started being used in disaster aid and search and rescue activities by police agencies and fire and disaster management agencies.

GNSS (or GPS) position determination has been mainly used in position determination for mobile objects. However, position information obtained by a global navigation satellite system (GNSS) may have an error of a few meters, as compared to actual position information. In this case, various risks may be increased by the error in the position information.

For example, as for a marine vessel traveling on an ocean, depending on any error in its position information, there is a problem that appropriate navigation is unable to be implemented and operation control upon landing gets out of order. Furthermore, for example, as for an autonomous driving car, depending on any error in its position information, there is a problem that the autonomous driving car deviates from a set movement route and the risk of accidents increases. Furthermore, for example, as for a drone, depending on any error in its position information, there is a problem of damage to objects by collision with walls and power transmission lines and increased risks to residents.

The Real Time Kinematic (RTK) method is increasingly utilized as a new position determination technique enabling position determination that is more accurate. In the RTK method, correction information is generated in real time on the basis of satellite data received by a base station fixed on the ground and a device that performs position determination calculates position information on the device itself on the basis of the correction information generated. Furthermore, the RTK method has an advantage of having an error of just a few centimeters and is considered to be effective for fields (for example, surveying, civil engineering, agriculture, and architecture) where highly accurate position determination is demanded.

However, the RTK method has a disadvantage that the cost for application of the RTK method is high because there is a need for installation of many base stations, for example.

The Precise Point Positioning (PPP) method is a position determination technique to compensate for the disadvantage of the RTK method. This PPP method has an advantages of not requiring any base station and being able to be used in a place where Internet communication is not possible. Furthermore, while the RTK method has a comparatively narrow cover range, the PPP method is able to cover a wide area just on the condition that satellite reception is possible, and the PPP method is thus considered to be effective in fields, such as shipping, marine, aviation, and meteorology. However, the PPP method has a disadvantage of having a larger error than the RTK method.

Accordingly, the RTK method and the PPP method have their advantages and disadvantages and need to be used according to the fields in which they are utilized. However, as described above, the RTK method is highly accurate but highly costly, the PPP method has uncertainty in terms of accuracy as compared to the RTK method, and thus using these methods wisely in a simple way is difficult.

The PPP-RTK method has thus attracted attention as a position determination technique that is a combination of the concepts of the PPP method and the RTK method. In this PPP-RTK method, for example, a device that performs position determination obtains correction information from a server as needed according to movement of a mobile object and performs error correction by using the correction information obtained. Because this one-way communication from the server to the device is performed, the PPP-RTK method has an advantage of enabling reduction in the amount of communication in Internet communication. Furthermore, because the number of base stations needed in this PPP-RTK method is much smaller than that in the RTK method, the PPP-RTK method has an advantage of reduced costs.

Furthermore, for these reasons, the PPP-RTK method also has an advantage of being applicable to a wide variety of mobile objects, such as marine vessels traveling in ocean regions where communication other than satellite communication is unstable, automobiles traveling in areas such as underpopulated areas where communication other than satellite communication is unstable, and air vehicles (for example, drones) flying between isolated islands where communication other than satellite communication is unstable.

In view of the above described points, with respect to embodiments, with a focus on a PPP method and a PPP-RTK method that enable the disadvantages of an RTK method to be solved; determination apparatuses, route determination systems, route determination methods, and system programs, to which these position determination techniques are applied, will be proposed. As described hereinafter, it should to be noted beforehand that the determination apparatuses, route determination systems, route determination methods, and system programs according to the embodiments are each not a simple combination of the conventional PPP method and the conventional RTK method.

Specifically, a determination apparatus according to an embodiment is a determination apparatus that performs communication with a terminal device that serves as a reference of a route for a mobile body. The terminal device obtains correction information generated on the basis of data received from a satellite and calculates position information on the terminal device itself, on the basis of the correction information obtained. The determination apparatus then determines a movement route for the mobile body on the basis of the position information calculated by the terminal device.

Furthermore, route determination processes according to the embodiments will be described separately hereinafter with respect to a first embodiment and a second embodiment. The first embodiment will be described with a focus, in particular, on a route determination process for marine vessels and a route determination process for autonomous driving cars, these route determination processes being scenes to which a determination apparatus, a route determination system, a route determination method, and a system program are applied. A route determination process for drones will then be described for the second embodiment.

### 2. Re Route Determination System

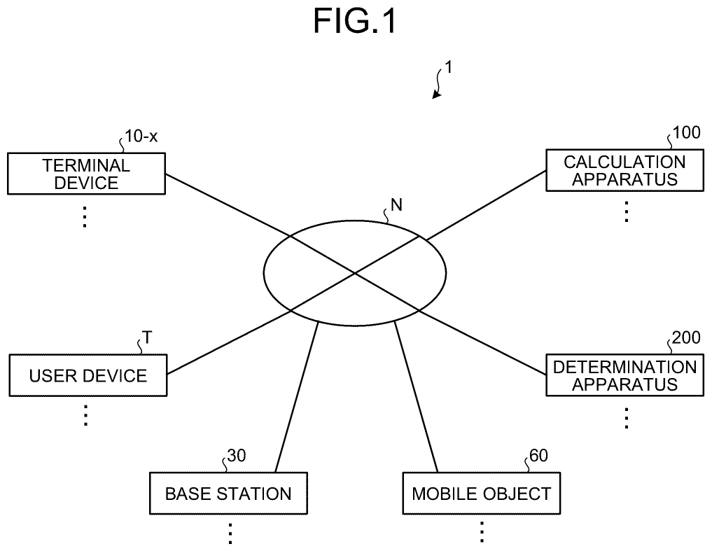

Before description of the route determination processes according to the embodiments, the route determination systems according to the embodiments will be described first. FIG. 1 is a diagram illustrating an example of the route determination systems according to the embodiments. FIG. 1 illustrates a route determination system 1 that is an example of the route determination systems according to the embodiments.

In the example of FIG. 1, the route determination system 1 may include a terminal device 10-x, a base station 30, a mobile object 60, a calculation apparatus 100, and a determination apparatus 200. The terminal device 10-x, the base station 30, the mobile object 60, the calculation apparatus 100, and the determination apparatus 200 may be communicably connected to one another by wire or wirelessly via a network N.

The terminal device 10-x may be a portable information processing terminal that is able to be installed at any place serving as a reference of a route for a mobile object. The terminal device 10-x may be a stationary information processing terminal installed fixedly at any place serving as a reference of a route for a mobile object. Furthermore, the terminal device 10-x may also be mounted in a mobile object itself.

Furthermore, the terminal device 10-x may be a terminal device owned by a user. Specifically, the terminal device 10-x may be a terminal device used by a user authorized to use the terminal device 10-x. Furthermore, the terminal device 10-x may be installed at any place corresponding to an intended use. For example, in a case where a user wants to inspect an exterior wall on a predetermined floor of a structure (for example, a building), the user will want to make the mobile object 60 (for example, a drone) fly along the exterior wall on that floor. In this case, the user may install terminal devices 10-x respectively at two aboveground ends of the building, the two ends corresponding to the wall. In this example, the two aboveground ends of the building are each an example of any place serving as a reference of a movement route and the places where the terminal devices 10-x are to be installed are not limited to this example. Furthermore, there are various methods for this installation and details of these methods will be described later.

Furthermore, the terminal device 10-x may receive a satellite signal. Specifically, the terminal device 10-x may receive a GNSS signal. Furthermore, a position determination module and an antenna for PPP position determination may be installed in the terminal device 10-x. Furthermore, a position determination module and an antenna for PPP-RTK position determination may be installed in the terminal device 10-x. Furthermore, in view of the above, a GNSS module including a GNSS receiver may be installed as the position determination module in the terminal device 10-x, for example. Furthermore, a communication module for communication with the calculation apparatus 100 and the determination apparatus 200 may be installed in the terminal device 10-x.

Furthermore, the terminal device 10-x may perform position determination on the basis of correction information. Specifically, the terminal device 10-x may receive correction information distributed from the calculation apparatus 100 and correct, on the basis of the correction information received, position information on the terminal device 10-x, the position information having been obtained from a satellite signal.

Specifically, the terminal device 10-x may correct the position information on the terminal device 10-x itself by PPP calculation using the correction information. That is, the terminal device 10-x may obtain corrected position information by the PPP calculation using the correction information. Furthermore, a program (for example, a system program according to an embodiment) enabling the PPP calculation to be executed may be installed on the terminal device 10-x. The PPP calculation may be executed by a conventional well-known method.

Furthermore, the terminal device 10-x may correct the position information on the terminal device 10-x by PPP-RTK calculation using the correction information. That is, the terminal device 10-x may obtain corrected position information by the PPP-RTK calculation using the correction information. Furthermore, a program (for example, a system program according to an embodiment) enabling the PPP-RTK calculation to be executed may be installed on the terminal device 10-x. The PPP-RTK calculation may be executed by a conventional well-known method.

In a case where terminal devices 10-x are to be distinguished from one another, the terminal devices 10-x will hereinafter be referred to as a terminal device 10-1, a terminal device 10-2, and so on by substitution of ‘x’ with numbers. Furthermore, a terminal device 10-x may simply be referred to as a terminal device 10.

The base station 30 may function as a base station in the PPP-RTK calculation. That is, coordinates indicating a position of the base station 30 may be known. Furthermore, in a case where there are plural base stations 30, coordinates of each of the plural base stations 30 may be known. Such known coordinates of the base stations 30 may hereinafter be referred to as known coordinates.

Furthermore, the base station 30 may have a receiving function of receiving satellite signals. Specifically, the base station 30 may have, as a GNSS signal receiving function enabling reception of GNSS signals, for example, an antenna and a GNSS module. That is, the base station 30 may receive GNSS signals. Furthermore, the base station 30 may transmit information on the known coordinates and information based on a GNSS signal to the calculation apparatus 100. The information based on the GNSS signal may include information indicating the satellite from which the GNSS signal was received and information related to the carrier wave, for example. Specifically, the base station 30 may transmit various types of information to the calculation apparatus 100 on the basis of, for example, the Radio Technical Commission For Maritime Services (RTCM) standards.

Furthermore, the base station 30 may be installed, as appropriate, at any point by any business operator, for example. Furthermore, the base station 30 may be installed by a business operator who performs maintenance of the route determination system 1, for example. Furthermore, the base station 30 may receive signals from a satellite other than the GNSS. For example, the base station 30 may receive signals from any other satellite, such as a regional navigation satellite system (RNSS).

The mobile object 60 may be a mobile means used differently by a user according to the use. Furthermore, a position determination module for determination of the position of the mobile object 60 may be installed in the mobile object 60. A terminal device 10-x may be installed as a device including a position determination module in the mobile object 60, for example. That is, the mobile object 60 may obtain corrected position information indicating the position of the mobile object 60 by PPP calculation using correction information. Furthermore, the mobile object 60 may obtain corrected position information indicating the position of the mobile object 60 by PPP-RTK calculation using correction information. As described above, the PPP calculation or the PPP-RTK calculation may be executed by a conventional well-known method.

Furthermore, the mobile object 60 and the terminal device 10-x may be separate devices. That is, a user may, for example, retrofit the terminal device 10-x to the mobile object 60 and cause the retrofitted terminal device 10-x to perform position determination for the mobile object 60. Furthermore, the mobile object 60 and the terminal device 10-x may be an integrated device.

Furthermore, the type of the mobile object 60 is not limited. For example, in a case where a movement route for the mobile object 60 is to be determined on the basis of position information obtained by PPP position determination, the mobile object 60 is preferably, for example, a marine vessel, which is a mobile object suitable for PPP position determination. Furthermore, for example, in a case where a movement route for the mobile object 60 is to be determined on the basis of position information obtained by PPP-RTK position determination, the mobile object 60 is preferably, for example, an automobile, which is a mobile object suitable for PPP-RTK position determination.

Furthermore, in either the case where the movement route for the mobile object 60 is to be determined on the basis of the position information obtained by PPP position determination or the case where the movement route for the mobile object 60 is to be determined on the basis of the position information obtained by PPP-RTK position determination, the mobile object 60 may be an air vehicle like a drone, for example.

Furthermore, a mobile device that is able to automatically control the mobile device itself may be installed in the mobile object 60. For example, the mobile device is a device for automatically controlling the mobile object 60 on the basis of route information obtained from the determination apparatus 200. The mobile device is able to automatically control the mobile object 60 to cause the mobile object 60 to move along a movement route determined by the determination apparatus 200, for example. The mobile device may be regarded as the mobile object 60. That is, the mobile device installed in the mobile object 60 may be referred to as the mobile device 60.

The calculation apparatus 100 may be a server device that performs various types of calculation for generating correction information. Firstly, a case where a movement route for the mobile object 60 is determined on the basis of position information obtained by PPP position determination will be described as an example. In this case, by using data received from plural satellites, the calculation apparatus 100 generates, for each of these satellites, correction information for correcting any error in position determination by a terminal device 10-x.

Specifically, the calculation apparatus 100 generates correction information for each of the plural satellites by generating correction information corresponding to that satellite on the basis of a GNSS signal received from the satellite. For example, by using the satellite orbit error and clock error, for example, the calculation apparatus 100 may generate correction information for each satellite on the basis of the satellite orbit error and clock error. Furthermore, the calculation apparatus 100 may broadcast, as a single set of correction information, a correction information list that is a list of correction information generated for the respective satellites, to a terminal device 10-x.

A case where a movement route for the mobile object 60 is determined on the basis of position information obtained by PPP-RTK position determination will be described next as an example. In this case, by using data received from plural satellites, the calculation apparatus 100 generates, for each area, correction information for correcting any error in position determination by a terminal device 10-x.

Specifically, for every area, the calculation apparatus 100 performs a process of generating correction information corresponding to the area on the basis of a GNSS signal directly received from a satellite and a GNSS signal indirectly received from the satellite via a base station 30. As a result, the calculation apparatus 100 obtains the correction information for each area.

For example, the calculation apparatus 100 generates correction information corresponding to an area, for which the process is to be performed, by using information estimated on the basis of a GNSS signal received from a satellite (for example, the satellite orbit error, the satellite clock error, the ionospheric delay error, the tropospheric delay error, and the satellite signal bias) and a GNSS signal received by a base station 30 corresponding to the area, for which the process is to be performed. Furthermore, by additionally combining information on the known coordinates of the base station 30 corresponding to the area, for which the process is to be performed, the calculation apparatus 100 generates correction information corresponding to this area, for which the process is to be performed. Furthermore, by performing this process for all areas, the calculation apparatus 100 obtains correction information corresponding to these areas.

Furthermore, the calculation apparatus 100 may broadcast, as a single set of correction information, a correction information list that is a list of correction information generated for the respective areas and gathered together, to a terminal device 10-x.

Furthermore, a GNSS module that receives a GNSS signal transmitted from a satellite and implements position determination (for example, PPP position determination or PPP-RTK position determination) based on the GNSS signal received may be installed in the calculation apparatus 100. Furthermore, the GNSS module may be an antenna-integrated GNSS module integrated with an antenna. However, the GNSS module is not necessarily integrated with an antenna, and in a case where the GNSS module is not integrated with an antenna, the calculation apparatus 100 has an antenna individually from the GNSS module. Furthermore, the antenna referred to herein may be a high performance antenna equivalent to, for example, a radar dome or a parabola antenna. As described above, the base station 30 has an antenna but the antenna that the calculation apparatus 100 has and the antenna that a base station has may have the same performance level or different performance levels.

In either the PPP position determination or the PPP-RTK position determination, the calculation apparatus 100 transmits the correction information generated, to a terminal device 10-x. Information included in the correction information is not limited to the above described example. The correction information may include any information needed for position determination calculation by the terminal device 10-x.

The following description is on an example of position determination using correction information. For example, by position determination based on a satellite signal, a terminal device 10-x calculates rough position information on the terminal device 10-x (rough position information). By correcting the rough position information using correction information obtained from the calculation apparatus 100, the terminal device 10-x then calculates position information that is more accurate. The terminal device 10-x thereby obtains corrected position information that is the position information that is more accurate.

The determination apparatus 200 may be a server apparatus that performs a route determination process according to an embodiment. The determination apparatus 200 may determine a movement route for the mobile object 60 by the route determination process according to the embodiment. Furthermore, the determination apparatus 200 may obtain corrected position information calculated by a terminal device 10-x from the terminal device 10-x. On the basis of the corrected position information obtained, the determination apparatus 200 may determine a movement route for the mobile object 60. The route determination process may be implemented by execution of a system program according to an embodiment at the determination apparatus 200.

### 3. Examples of Overall Route Determination Process

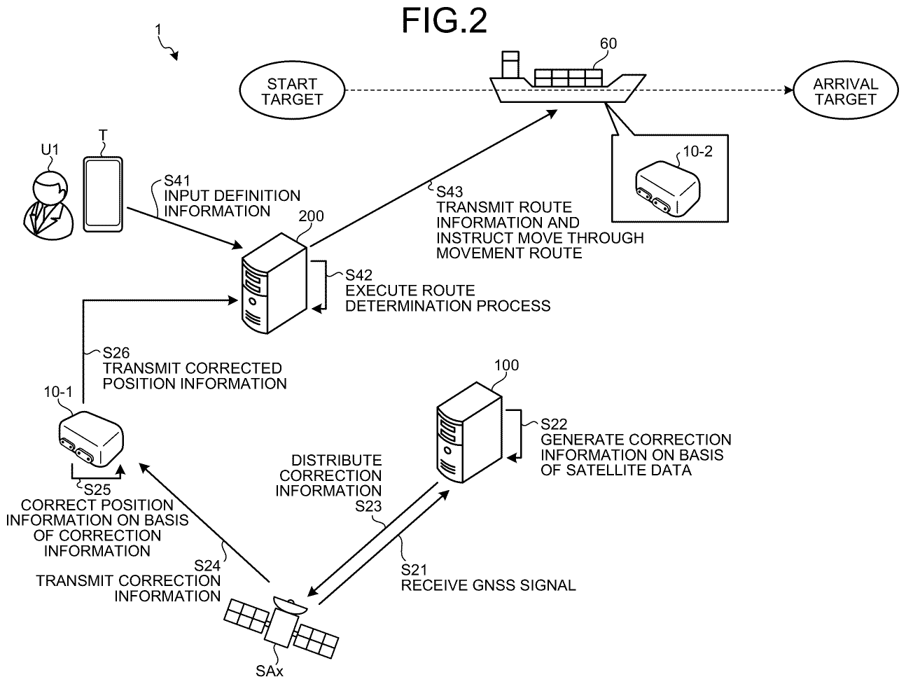

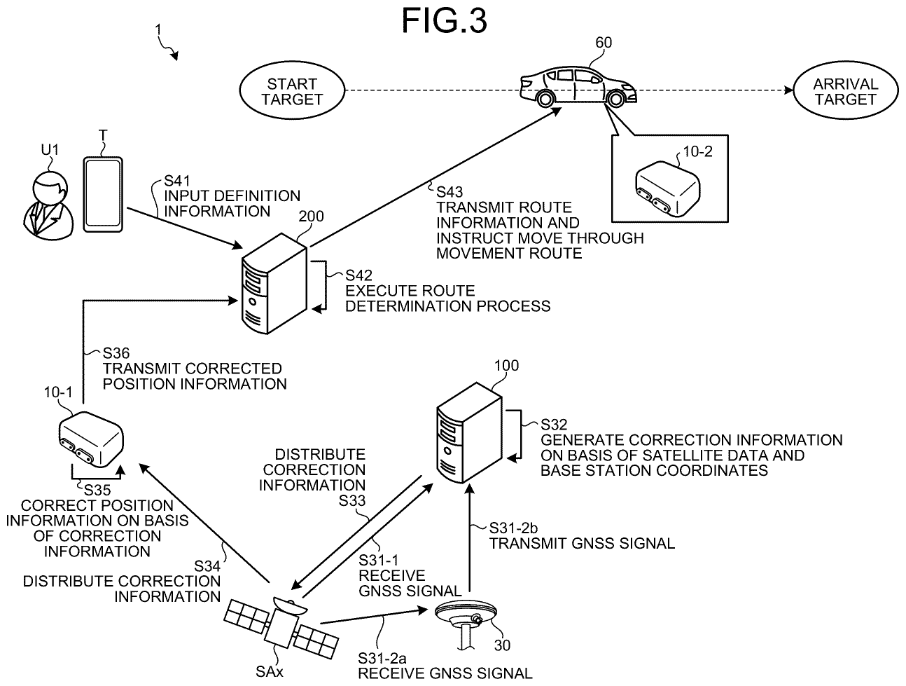

Examples of an overall flow of a route determination process according to an embodiment will be described hereinafter by use of FIG. 2 and FIG. 3. FIG. 2 illustrates a situation where a movement route for a mobile object 60 is determined on the basis of position information obtained by PPP position determination. Furthermore, FIG. 3 illustrates a situation where a movement route for a mobile object 60 is determined on the basis of position information obtained by PPP-RTK position determination. Furthermore, the same reference sign is assigned to any step common to FIG. 2 and FIG. 3. Furthermore, in the examples of FIG. 2 and FIG. 3 described hereinafter, GNSS signals are used as satellite signals in the route determination processes.

### 3-1. First Example of Overall Route Determination Process

An overall flow of the route determination process according to the embodiment will be described first by use of FIG. 2. FIG. 2 is a first diagram illustrating an overview of the route determination process according to the embodiment. FIG. 2 illustrates an example where the mobile object 60 is a marine vessel and a movement route for automatic control of movement of the marine vessel is determined. Furthermore, in a case where movement of a marine vessel is desired to be automatically controlled like in this example, a terminal device 10-x may be installed at any place according to a purpose of a user.

For example, in the example of FIG. 2, it is assumed that a user U1 wants to cause the mobile object 60 currently stopping on the sea to move to a destination (arrival target) that is on a specific shore from its current location (start target) and cause the mobile object 60 to land on the shore there. In this case, the user U1 may use, for example, two terminal devices 10-x as illustrated in FIG. 2. Specifically, the user U1 may install one terminal device 10-1 (an example of a terminal device 10-x) at the destination corresponding to the arrival target and another terminal device 10-2 (an example of a terminal device 10-x) at the current location (that is, the mobile object 60) corresponding to the start target.

In the example of FIG. 2, the user U1 may be a person waiting for the mobile object 60 to come to the shore or a person (for example, an operator) actually boarding the mobile object 60.

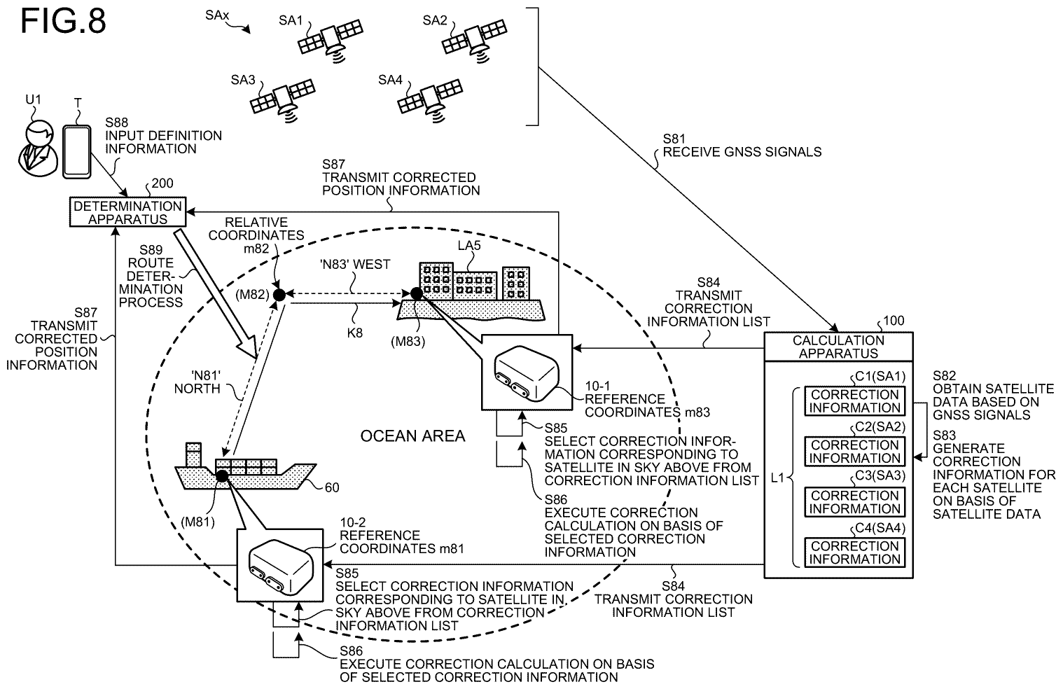

Furthermore, with respect to FIG. 2, an overview of the route determination process will be described with a focus on the terminal device 10-1 of the terminal devices 10-1 and 10-2, but a similar process may be performed with respect to the terminal device 10-2. Furthermore, a more specific example of the process corresponding to FIG. 2 will be described later by reference to FIG. 8.

Firstly, in the example of FIG. 2, a satellite SAx is transmitting a GNSS signal. In this case, the calculation apparatus 100 receives the GNSS signal transmitted by the satellite SAx (Step S21). FIG. 2 illustrates one satellite SAx but the calculation apparatus 100 may receive GNSS signals transmitted by plural satellites SAx.

Furthermore, in response to the calculation apparatus 100 receiving the GNSS signal, the calculation apparatus 100 generates correction information for PPP position determination by a calculation algorithm using information (that is, satellite data) based on the GNSS signal received (Step S22). For example, by generating correction information corresponding to the satellites SAx on the basis of the GNSS signals received from the satellites SAx, the calculation apparatus 100 generates correction information for each of the plural satellites SAx. For example, for each of the satellites SAx that have transmitted the GNSS signals, the calculation apparatus 100 generates correction information corresponding to that satellite SAx by using a calculation algorithm based on the satellite data received from the satellite SAx.

The satellite data may include various types of information, such as information indicating the satellite that has transmitted the GNSS signal and carrier wave information, and the calculation apparatus 100 generates, for each of the satellites SAx, the correction information for the PPP position determination by using the calculation algorithm based on the satellite data. For example, by using the satellite orbit error and clock error, the calculation apparatus 100 may generate the correction information for each satellite SAx on the basis of the satellite orbit error and clock error.

Furthermore, the calculation apparatus 100 distributes the correction information generated, to the satellite SAx (Step S23). For example, the calculation apparatus 100 generates a list of correction information by gathering together correction information obtained respectively for the satellites SAx and distributes the list of correction information to the satellite SAx so that the generated list of correction information is broadcasted to the terminal device 10-1. For example, the calculation apparatus 100 may distribute the list of correction information to one of the plural satellites SAx, the one being in the sky over the terminal device 10-1.

The satellite SAx that has received the list of correction information transmits or broadcasts the list of correction information to the terminal device 10-1 (Step S24). FIG. 2 illustrates the example in which the correction information is distributed from the calculation apparatus 100 to the terminal device 10-1 via the satellite SAx, but the list of correction information may be distributed directly from the calculation apparatus 100 to the terminal device 10-1 without being distributed via the satellite SAx.

The terminal device 10-1 may, for example, calculate position information indicating the position of the terminal device 10-1 (the position where the terminal device 10-1 has been installed) by GNSS position determination based on a GNSS signal, in response to the terminal device 10-1 being activated after installation. This position information may be position information that is rough (rough position information), the position information capable of indicating a position in a range of a few meters around the actual position of the terminal device 10-1. Furthermore, the terminal device 10-1 may transmit the rough position information calculated, to the calculation apparatus 100. For example, by periodically calculating its rough position information, the terminal device 10-1 may transmit the rough position information a plural number of times to the calculation apparatus 100, and not just for the very first time after being activated. The terminal device 10-1 may though transmit the rough position information to the calculation apparatus 100 only at the time the terminal device 10-1 is activated for the first time after being installed, for example.

In the example of FIG. 2, the terminal device 10-1 may continue to receive correction information distributed from the calculation apparatus 100 via the satellite SAx in a state where the terminal device 10-1 is calculating its rough position information. That is, the terminal device 10-1 continues to obtain correction information generated on the basis of satellite data from the satellite SAx.

In response to the terminal device 10-1 obtaining the correction information, the terminal device 10-1 executes calculation for correcting the position information on the basis of the correction information obtained (Step S25). For example, the terminal device 10-1 detects one of the satellites SAx as a satellite SAx for which a process is to be performed, the one moving in a predetermined range in the sky over the terminal device 10-1. For example, because the terminal device 10-1 is able to receive signals from a satellite SAx that is moving in the predetermined range in the sky over the terminal device 10-1, the terminal device 10-1 may detect the satellite SAx for which a process is to be performed, on the basis of whether or not the terminal device 10-1 was able to receive a signal. Furthermore, the terminal device 10-1 selects correction information corresponding to the satellite SAx for which a process is to be performed, from a list of correction information, the selected correction information being of the correction information obtained, that is, from the correction information generated respectively for the satellites SAx. The terminal device 10-1 may then calculate corrected position information by correcting the rough position information by PPP calculation using the selected correction information. This position information calculated is position information that is more accurate than the rough position information.

Subsequently, the terminal device 10-1 transmits the corrected position information to the determination apparatus 200 (Step S26). In this case, the determination apparatus 200 obtains the corrected position information from the terminal device 10-1.

Furthermore, although this is not illustrated in FIG. 2, the determination apparatus 200 may store the corrected position information obtained, into a storage unit 220. For example, the determination apparatus 200 may store identification identifying the terminal device 10-1 and the corrected position information obtained through the PPP calculation by the terminal device 10-1, in association with each other, into the storage unit 220.

Furthermore, as described above, the terminal device 10-1 may calculate the rough position information and correction information may continue to be transmitted from the calculation apparatus 100 to the terminal device 10-1 by one-way communication. In this case, the terminal device 10-1 may repeat Step S25 in response to the continued reception of correction information. Furthermore, the corrected position information obtained every time Step S25 is repeated may be accumulated in the storage unit 220 of the determination apparatus 200.

Furthermore, the determination apparatus 200 may obtain definition information defining a movement route for the mobile object 60. Furthermore, the determination apparatus 200 may determine whether or not the definition information has been received. The definition information may include, for example, information indicating a target point (start target) where movement of the mobile object 60 is started and information indicating a target point (arrival target) where the mobile object 60 is cause to arrive.

For example, the definition information may include information indicating a direction, a distance, a height, and an angle, with the terminal device 10-1 being the point of origin. For example, the definition information may define a start target and an arrival target by information on, for example, a direction, a distance, a height, and an angle, with the terminal device 10-1 being the point of origin. In another example, the definition information may include information indicating, for example, a direction, a distance, a height, and an angle, with the terminal device 10-2 being the point of origin. That is, the definition information may define a start target and an arrival target by information on, for example, a direction, a distance, a height, and an angle, with the terminal device 10-2 being the point of origin.

The determination apparatus 200 may obtain the definition information via, for example, a user device T through which the definition information is able to be input. In the example of FIG. 2, the user U1 inputs the definition information by using the user device T (Step S41). An application (hereinafter, referred to as the ‘application AP’) for various types of setting for control related to the mobile object 60 may be installed on the user device T beforehand. In this case, the determination apparatus 200 may obtain the definition information input by the user U1 via the application AP.

On the basis of this definition information and the corrected position information obtained at Step S26, the determination apparatus 200 executes a route determination process of determining a movement route for the mobile object 60 (Step S42). For example, in the route determination process, on the basis of the definition information and the corrected position information, the determination apparatus 200 may calculate a target point satisfying the definition information. For example, on the basis of the definition information and the corrected position information, the determination apparatus 200 may calculate a start target point (start target) where movement of the mobile object 60 is started and an arrival target point (arrival target) where the mobile object 60 is caused to arrive.

More specifically, the determination apparatus 200 may calculate a relative position with reference to the corrected position information. For example, the determination apparatus 200 may calculate, as positions of target points (start target and arrival target), relative positions satisfying the definition information. The determination apparatus 200 may then calculate a path of movement of the mobile object 60, with the calculated positions serving as targets, and determine that path as a movement route for the mobile object 60. That is, on the basis of the corrected position information and the definition information, the determination apparatus 200 may calculate the positions of the start target and arrival target and determine, as the movement route, the path for movement of the mobile object 60 from the start target to the arrival target. The movement route may include, for example a path for the mobile object 60 to arrive at the start target from its current position. Furthermore, the movement route may include, for example, a path for the mobile object 60 to leave the arrival target.

Furthermore, the determination apparatus 200 may calculate the position of the start target on the basis of the latest corrected position information of corrected position information that has been accumulated. For example, the determination apparatus 200 may calculate, as the position of the start target, a relative position with reference to the position indicated by the latest corrected position information, the relative position satisfying the definition information. Furthermore, the determination apparatus 200 may calculate, as the position of the arrival target, a relative position with reference to the position indicated by the latest corrected position information of the corrected position information that has been accumulated, the relative position satisfying the definition information. The determination apparatus 200 may then determine, as the movement route for the mobile object 60, a path for movement of the mobile object 60 from the start target to the arrival target.

Subsequently, by transmitting information (route information) indicating the movement route determined at Step S42 to the mobile object 60, the determination apparatus 200 instructs the mobile object 60 to move through the movement route indicated by the route information (Step S43).

The mobile object 60 may move on the basis of the route information. For example, in a case where the mobile object 60 has obtained the route information from the determination apparatus 200, the mobile object 60 may start moving to the start target based on the route information by automatically controlling its movement. Furthermore, in a case where the mobile object 60 has arrived at the start target, the mobile object 60 may move toward the arrival target according to the route indicated by the route information by automatically controlling its movement.

As described above, the mobile object 60 may have the terminal device 10-2 installed therein as a position determination module and obtain corrected position information indicating its own position, as appropriate. In this case, the mobile object 60 may move while comparing the current position indicated by the latest corrected position information and the path indicated by the route information obtained. Specifically, the mobile object 60 may move while adjusting its current position, to move along the path, by comparing the current position with the position on the path. The mobile object 60 may move toward the arrival target while performing adjustment to not deviate from the position on the path, for example. The mobile object 60 may continuously obtain corrected position information.

### 3-2. Second Example of Overall Route Determination Process

An overall flow of the route determination process according to the embodiment will be described next by use of FIG. 3. FIG. 3 is a second diagram illustrating an overview of the route determination process according to the embodiment. FIG. 3 illustrates an example where the mobile object 60 is an autonomous driving car and a movement route for automatic control of movement of the autonomous driving car is determined. Furthermore, in a case where movement of an autonomous driving car is desired to be automatically controlled like in this example, a terminal device 10-x may be installed at any place according to a purpose of a user.

For example, in the example of FIG. 3, it is assumed that a user U1 wants to cause the mobile object 60 currently stopping on a predetermined road to move to a destination (arrival target) that is present on a specific road, from its current location (start target). In this case, the user U1 may use, for example, two terminal devices 10-x as illustrated in FIG. 3. Specifically, the user U1 may install one terminal device 10-1 (an example of a terminal device 10-x) at the destination corresponding to the arrival target and another terminal device 10-2 (an example of a terminal device 10-x) at the current location (that is, the mobile object 60 itself) corresponding to the start target.

In the example of FIG. 3, the user U1 may be a person waiting for the mobile object 60 to come to the destination or a person (for example, a driver) actually riding the mobile object 60.

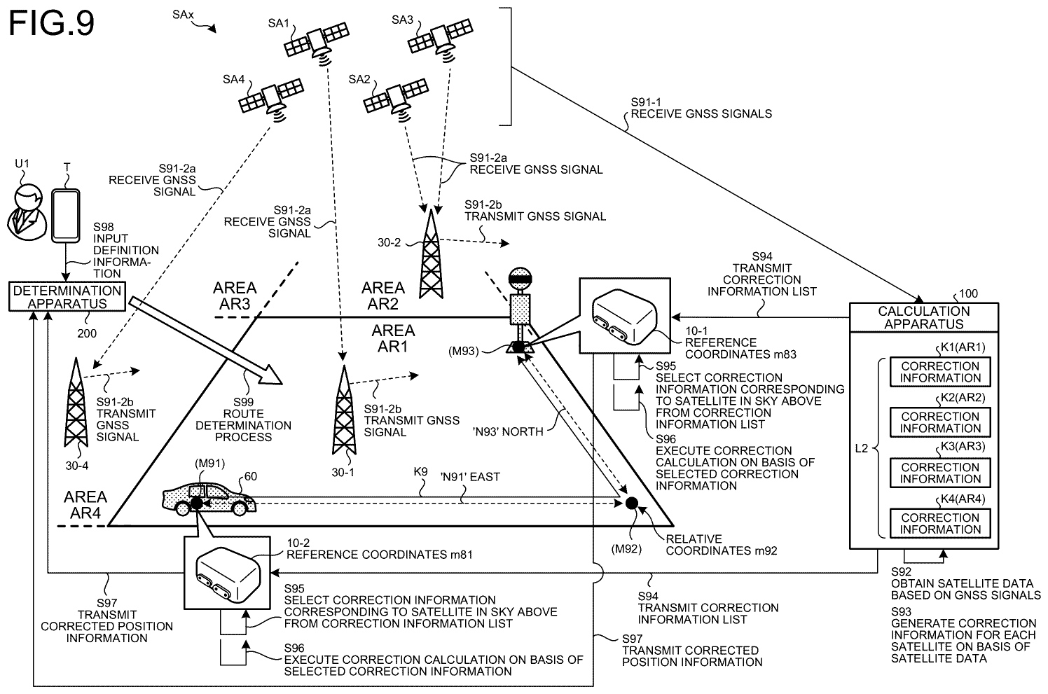

Furthermore, in the example of FIG. 3 also, an overview of the route determination process will be described with a focus on the terminal device 10-1 of the terminal device 10-1 and terminal device 10-2, but a similar process may be performed with respect to the terminal device 10-2. Furthermore, a more specific example of a process corresponding to FIG. 3 will be described later by use of FIG. 9.

FIG. 2 illustrates the example where a movement route is determined by use of a result of position determination by PPP position determination, but FIG. 3 illustrates an example where a movement route is determined by use of a result of position determination by PPP-RTK position determination. Accordingly, a route determination system 1 illustrated in FIG. 3 further includes a base station 30, as compared to the route determination system illustrated in FIG. 2. The position of the base station 30 has coordinates that are known (known coordinates). Furthermore, by this inclusion of the base station 30, a process different in part from that in the example of FIG. 2 is performed.

In the example of FIG. 3, similarly to FIG. 2, a satellite SAx is transmitting a GNSS signal. In this case, the calculation apparatus 100 receives the GNSS signal transmitted by the satellite SAx (Step S31), but the calculation apparatus 100 may receive the GNSS signal through two different routes (Step S31-1 and Step S31-2) at this Step S31. For example, the calculation apparatus 100 receives the GNSS signal directly from the satellite SAx in one of these routes, as illustrated in FIG. 3 (Step S31-1).

FIG. 3 illustrates one satellite SAx but the calculation apparatus 100 may receive GNSS signals transmitted by plural satellites SAx at Step S31-1.

Furthermore, the calculation apparatus 100 receives the GNSS signal via the base station 30 through the other route (Step S31-2). At Step S31-2, the base station 30 receives the GNSS signal from the satellite SAx (Step S31-2a). For example, the base station 30 may be constantly receiving the GNSS signal and may transmit the GNSS signal received to the calculation apparatus 100 (Step S31-2b). As a result, the calculation apparatus 100 receives the GNSS signal via the base station 30.

FIG. 3 illustrates one satellite SAx but the base station 30 may receive GNSS signals transmitted by plural satellites SAx at Step S31-2a. Furthermore, FIG. 3 illustrates one base station 30, but there may actually be plural base stations 30. Accordingly, in a case where plural base stations 30 are present, at Step S31-2a, depending on their positional relations, some of these base stations 30 receive a GNSS signal transmitted by one satellite SAx and some receive GNSS signals transmitted by plural satellites SAx.

Furthermore, in a case where there are plural base stations 30, each of these base stations 30 transmits a GNSS signal that it has received, to the calculation apparatus 100, at Step S31-2b. Furthermore, as described above, because each of the base stations 30 has known coordinates that are accurate coordinates that have been measured, each of the base stations 30 may transmit information on its own known coordinates to the calculation apparatus 100 at Step 31-2b.

Furthermore, in response to a distribution request from the calculation apparatus 100, the base station 30 may transmit information based on a GNSS signal, to the calculation apparatus 100.

Both the calculation apparatus 100 and the base station 30 have an antenna for receiving GNSS signals, but their antennas may have performance levels different from each other. For example, the antenna that the calculation apparatus 100 has may be a radar dome or a huge parabola antenna and the antenna that the base station 30 has may be a GNSS module. In this case, pieces of information received by these antennas are different from each other. Therefore, information included in the GNSS signal obtained by the calculation apparatus 100 from the satellite SAx through the route of Step S31-1 may be different from information included in the GNSS signal obtained by the calculation apparatus 100 from the base station 30 through the route of Step S31-2. Accordingly, by obtaining the GNSS signals through these two different routes, the calculation apparatus 100 is able to generate correction information that is more accurate.

With reference back to FIG. 3, the calculation apparatus 100 generates correction information for PPP-RTK position determination by a calculation algorithm using information (that is, satellite data) based on the GNSS signal obtained from the satellite SAx through the route of Step S31-1 and the GNSS signal obtained from the base station 30 through the route of Step S31-2 (Step S32). For example, the calculation apparatus 100 generates correction information corresponding to each of predetermined areas on the basis of GNSS signals obtained from plural satellites SAx at Step S31-1 and GNSS signals obtained from plural base stations 30 at Step S32-2a and Step S32-2b.

For example, the calculation apparatus 100 may generate correction information for each of predetermined areas on the basis of GNSS signals obtained from plural satellites SAx and GNSS signals obtained from plural base stations 30.

These predetermined areas may refer respectively to plural areas predetermined by division into blocks based on any method. Or, the predetermined areas may refer respectively to plural areas set on the basis of information related to errors, such as the satellite orbit error, satellite clock error, the ionospheric delay error, the tropospheric delay error, and the satellite signal bias. Furthermore, the predetermined areas referred to herein may each be a planar area on the ground surface or a spatial area having the concept of height in relation to this planar area. Such areas may hereinafter be referred to as ‘areas according to the embodiment’.

A base station 30 is not necessarily located in each of the areas according to the embodiment and in a case where base stations 30 are located in the areas, the number of base stations 30 therein is not limited. That is, an area where no base station 30 is located, an area where only one base station 30 is located, and an area where plural base stations 30 are located may be present in the areas according to the embodiment.

Furthermore, the calculation apparatus 100 may generate correction information for each of the areas according to the embodiment by using a calculation algorithm according to how base stations 30 are located in the areas according to the embodiment.

Through such a calculation algorithm, the calculation apparatus 100 is able to generate correction information on, for example, an area where no base station 30 is located, by using information corresponding to a base station 30 located in an area adjacent or close to that area.

Furthermore, through such a calculation algorithm, the calculation apparatus 100 is able to generate correction information on, for example, an area where a base station 30 is located, by using only information corresponding to this base station 30 located therein. Or, the calculation apparatus 100 may generate correction information on, for example, an area where a base station 30 is located, by using, in addition to information corresponding to this base station 30 located therein, information corresponding to a base station 30 located in an area adjacent or close to this area.

An example of a process in which correction information is generated by the calculation apparatus 100 will be described hereinafter. The calculation apparatus 100 generates correction information corresponding to each of the areas according to the embodiment, according to, for example, a calculation algorithm like the one described above.

For example, for each of the areas according to the embodiment, the calculation apparatus 100 generates correction information corresponding to the area on the basis of GNSS signals received from plural satellites SAx corresponding to the area and GNSS signals received by plural base stations 30 corresponding to the area. For example, the calculation apparatus 100 generates correction information corresponding to an area according to the embodiment on the basis of information (satellite data) based on GNSS signals received from plural satellites SAx and information (satellite data) based on GNSS signals received by plural base stations 30.

The plural base stations 30 corresponding to the area herein may be base stations 30 identified according to how base stations 30 are located in the area according to the embodiment and how base stations 30 are located in an area adjacent or close to that area.

Through a calculation algorithm using satellite data obtained from plural satellites SAx corresponding to the areas according to the embodiment and satellite data obtained from plural base stations 30 corresponding to the areas according to the embodiment, the calculation apparatus 100 may generate correction information for PPP-RTK position determination for each of the areas according to the embodiment.

For example, in a case where four areas AR1, AR2, AR3, and AR4 have been set as the areas according to the embodiment, the calculation apparatus 100 generates correction information for each of these four areas.

Furthermore, the calculation apparatus 100 distributes the correction information generated, to a satellite SAx (Step S33). For example, the calculation apparatus 100 generates a list of correction information by gathering together correction information obtained for each of the areas according to the embodiment and distributes the list of correction information generated, to a satellite SAx so that the generated list of correction information is broadcasted to the terminal device 10-1. For example, the calculation apparatus 100 may transmit the list of correction information to a satellite SAx of plural satellites SAx, the satellite SAx being in the sky over the terminal device 10-1.

The satellite SAx that has received the list of correction information distributes or broadcasts the list of correction information to the terminal device 10-1 (Step S34). FIG. 3 illustrates the example in which the correction information is distributed from the calculation apparatus 100 to the terminal device 10-1 via the satellite SAx, but the list of correction information may be distributed directly from the calculation apparatus 100 to the terminal device 10-1 without being distributed via the satellite SAx.

In response to the terminal device 10-1 obtaining the correction information, the terminal device 10-1 executes calculation for correcting position information on the basis of the correction information obtained (Step S35). For example, the terminal device 10-1 may calculate position information indicating the position of the terminal device 10-1 (the position where the terminal device 10-1 has been installed) by GNSS position determination based on a GNSS signal. This position information may be position information that is rough (rough position information), the position information capable of indicating a position in a range of a few meters around the actual position of the terminal device 10-1.

The terminal device 10-1 selects correction information generated for an area of the areas according to the embodiment from the list of correction information, the area corresponding to the position indicated by the rough position information calculated. The terminal device 10-1 may then calculate corrected position information by correcting the rough position information by PPP-RTK calculation using the correction information selected. This position information calculated is position information that is more accurate than the rough position information.

Subsequently, the terminal device 10-1 transmits the corrected position information to the determination apparatus 200 (Step S36). In this case, the determination apparatus 200 obtains the corrected position information from the terminal device 10-1. Steps S41 to S43 subsequently performed by the determination apparatus 200 are similar to those in FIG. 2 and description thereof will thus be simplified.

In the example of FIG. 3 also, the user U1 inputs definition information to the determination apparatus 200 by using a user device T (Step S41).

In response to the determination apparatus 200 obtaining the definition information, on the basis of this definition information and the corrected position information obtained at Step S36, the determination apparatus 200 executes a route determination process of determining a movement route for the mobile object 60 (Step S42). For example, in the route determination process, on the basis of the definition information and the corrected position information, the determination apparatus 200 may calculate a target point satisfying the definition information. For example, on the basis of the definition information and the corrected position information, the determination apparatus 200 may calculate a start target point (start target) where movement of the mobile object 60 is to be started and an arrival target point (arrival target) where the mobile object 60 is caused to arrive.

More specifically, the determination apparatus 200 may calculate a relative position with reference to the corrected position information. For example, the determination apparatus 200 may calculate, as positions of target points (start target and arrival target), relative positions satisfying the definition information. The determination apparatus 200 may then calculate a path of movement of the mobile object 60, with the calculated positions being targets, and determine that path as a movement route for the mobile object 60. That is, on the basis of the corrected position information and the definition information, the determination apparatus 200 may calculate the positions of the start target and arrival target and determine, as the movement route, a path for movement of the mobile object 60 from the start target to the arrival target.

Subsequently, by transmitting information (route information) indicating the movement route determined at Step S42 to the mobile object 60, the determination apparatus 200 instructs the mobile object 60 to move through the movement route indicated by the route information (Step S43).

The mobile object 60 may move on the basis of the route information. For example, in a case where the mobile object 60 has obtained the route information from the determination apparatus 200, the mobile object 60 may start moving toward the start target based on the route information by automatically controlling its movement. Furthermore, in a case where the mobile object 60 has arrived at the start target, the mobile object 60 may move toward the arrival target according to a route indicated by the route information by automatically controlling its movement.

The route determination process utilizing the PPP method (or the PPP-RTK method) has been described thus far by use of FIG. 2 and FIG. 3. Furthermore, as described by reference to FIG. 2 and FIG. 3, in the route determination process according to the embodiment, dedicated terminal devices 10 capable of performing calculation compatible with the PPP method (or the PPP-RTK method) are used.

As a result, a user is able to provide accurate position information to a mobile object 60 by installing a terminal device 10-x at any place serving as a reference of a movement route, for example. For example, by defining a target point, with a terminal device 10-x being the point of origin, a user is able to provide accurate position information to a mobile object 60. That is, on the basis of corrected position information obtained by the terminal device 10-x, the determination apparatus 200 is able to determine an optimum movement route.

Accordingly, the route determination process according to the embodiment allows a user to set an accurate target point easily. Furthermore, by using a terminal device 10-x that is portable, the user is able to perform route setting having a high degree of freedom. Therefore, the route determination process according to the embodiment enables improvement of usability in route setting.

Furthermore, as described by reference to FIG. 2 and FIG. 3, in the route determination process according to the embodiment, in a case where the PPP method is adopted, correction information is generated for each of satellites SAx at the calculation apparatus 100 and the correction information generated is transmitted to a terminal device 10-x. As a result, the terminal device 10-x selects correction information generated for a satellite SAx corresponding to the terminal device 10-x (the satellite SAx in the sky over the terminal device 10-x) from the correction information for each of the satellites SAx (a list of correction information) obtained from the calculation apparatus 100 and corrects its rough position by PPP calculation using the correction information selected.

In a case where the PPP-RTK method is adopted, correction information is generated at the calculation apparatus 100 for each of the areas according to the embodiment and the correction information generated is transmitted to a terminal device 10-x. As a result, the terminal device 10-x selects correction information generated for an area where the terminal device 10-x is present from the correction information for each of the areas (a list of correction information) obtained from the calculation apparatus 100 and corrects its rough position by PPP-RTK calculating using the correction information selected.

As described above, in a configuration where generation of correction information and transmission of the correction information to a terminal device 10-x are performed at the calculation apparatus 100 and correction information needed in correction calculation is selected at the terminal device 10-x, the calculation apparatus 100 is able to dynamically generate correction information by utilizing satellite communication and to transmit the correction information via satellite communication to the terminal device 10-x, without need for access (for example, transmission of rough location information) from the terminal device 10-x via Internet communication. As a result, the terminal device 10-x is also able to perform obtainment of correction information and correction calculation without need for Internet communication.

Therefore, the PPP method according to the embodiment and the PPP-RTK method according to the embodiment, which have been described thus far, enable implementation of accurate position determination on an ocean or in an underpopulated area where Internet communication is unstable, and thus provide a large advantage particularly in a situation where a marine vessel traveling on an ocean or an autonomous driving car traveling in an underpopulated area is to be controlled by use of position information.

### 4. Variations of Definition Information

Definition information utilizing a terminal device 10 may be freely set according to a use situation where the terminal device 10 is used or a purpose of a user.

Furthermore, definition information may include information prescribing a virtual area where a mobile object 60 is caused to move in a space where the mobile object 60 is movable. The virtual area may be three-dimensional or planar and is not particularly limited. That is, the definition information may define a virtual planar area and a virtual spatial area where the mobile object 60 is moved.

Furthermore, in a case where definition information prescribes a polygonal area, for example, the definition information may include information indicating points (vertex points) at vertices of the area. Furthermore, in a case where definition information prescribes a circular or spherical area, for example, the definition information may include information indicating a point (center point) at the center of the area and information indicating the size of its radius. Furthermore, in a case where definition information prescribes an area that is a combination of a polygonal area and a circular or spherical area, the definition information may include information that is a combination of information for prescribing these shapes, as appropriate. Furthermore, definition information may include, for example, information indicating a position of a terminal device 10-x, information indicating a height with the terminal device 10-x being the point of origin, and information indicating a height of the terminal device 10-x.

### 5. Configuration of Each Device/Apparatus

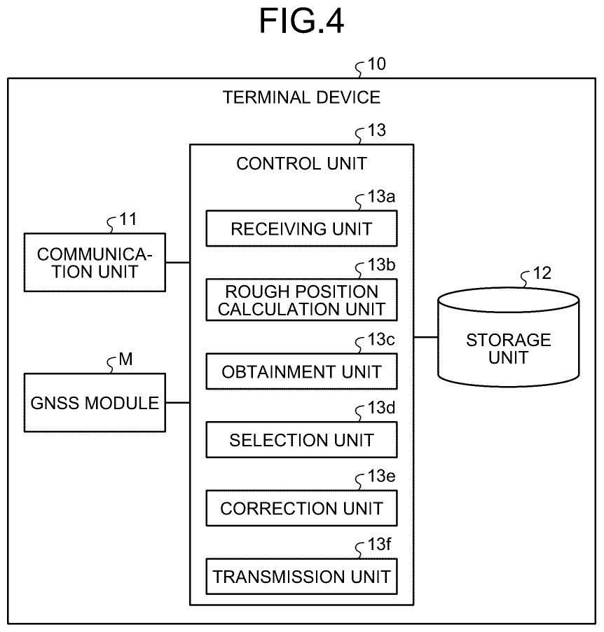

A configuration of each device or apparatus included in a route determination system 1 according to an embodiment will be described next by use of FIG. 4 to FIG. 7.

### 5-1. Configuration of Terminal Device

FIG. 4 is a diagram illustrating an example of a configuration of a terminal device 10 according to the embodiment. The terminal device 10 may have a communication unit 11, a GNSS module M, a storage unit 12, and a control unit 13.

### Re Communication Unit 11 and GNSS Module M

The communication unit 11 may be implemented by, for example, a network interface card (NIC). The communication unit 11 may be connected to the network N by wire of wirelessly. The communication unit 11 may, for example, transmit and receive information to and from the calculation apparatus 100 and the determination apparatus 200, via the network N. The GNSS module M is capable of receiving GNSS signals. That is, the GNSS module M may include any component for receiving GNSS signals.

### Re Storage Unit 12

The storage unit 12 may be implemented by, for example, a semiconductor memory element, such as a random access memory (RAM) or a flash memory, or a storage device, such as a hard disk or an optical disk. The storage unit 12 may store, for example, rough position information calculated by a rough position calculation unit 13b, correction information received from the calculation apparatus 100, and corrected position information by PPP calculation or RTK calculation using the correction information.

### Re Control Unit 13

The control unit 13 may be implemented by various programs being executed by a central processing unit (CPU), a graphics processing unit (GPU) or a micro processing unit (MPU), for example, the various programs having been stored in a storage device inside the terminal device 10, with a RAM serving as a work area. Furthermore, the control unit 13 may be implemented by, for example, an integrated circuit, such as an application specific integrated circuit (ASIC) or a field programmable gate array (FPGA).

The control unit 13 may have a receiving unit 13a, the rough position calculation unit 13b, an obtainment unit 13c, a selection unit 13d, a correction unit 13e, and a transmission unit 13f. The internal configuration of the control unit 13 is not limited to the configuration illustrated in FIG. 4, and may be any other configuration configured to execute information processing described later. Furthermore, the processing units included in the control unit 13 may have any other connective relations instead, without being limited to the connective relations illustrated in FIG. 4.

### Re Receiving Unit 13a

The receiving unit 13a corresponds to a GNSS receiver and an antenna and may receive GNSS signals. Furthermore, the receiving unit 13a may output a GNSS signal received, to the rough position calculation unit 13b.

### Re Rough Position Calculation Unit 13b

By GNSS position determination based on a GNSS signal received by the receiving unit 13a, the rough position calculation unit 13b may calculate position information indicating the position (the position where the terminal device 10 has been installed) of the terminal device 10. That is, by the GNSS position determination based on the GNSS signal, the rough position calculation unit 13b may calculate rough position information. For example, in a case where activation has been detected, the rough position calculation unit 13b may calculate rough position information. The rough position calculation unit 13b may store the rough position information calculated, into the storage unit 12. Furthermore, the rough position calculation unit 13b may transmit the rough position information to the calculation apparatus 100.

### Re Obtainment Unit 13c

The obtainment unit 13c obtains correction information generated on the basis of satellite data received from a satellite.

For example, on the basis of data received from an artificial satellite, the data being data received from the artificial satellite, the obtainment unit 13c obtains correction information generated at the calculation apparatus 100.

In a case where the PPP method is adopted, as described by reference to FIG. 2, the calculation apparatus 100 may generate correction information for PPP position determination for each artificial satellite by using data received from the artificial satellite. Therefore, in this case, the obtainment unit 13c may obtain correction information for PPP position determination generated for each artificial satellite, from the calculation apparatus 100.

Furthermore, the calculation apparatus 100 transmits correction information (for example, a list of correction information) for PPP position determination generated for each artificial satellite, to the terminal device 10, but the correction information may be directly transmitted to the terminal device 10 or the correction information may be transmitted to the terminal device 10 via an artificial satellite. Therefore, the obtainment unit 13c may obtain correction information transmitted directly from the calculation apparatus 100 or may obtain correction information transmitted from the calculation apparatus 100 via an artificial satellite.

In a case where the PPP-RTK method is adopted, as described by reference to FIG. 3, the calculation apparatus 100 may generate correction information for PPP-RTK position determination for each of predetermined areas (that is, the areas according to the embodiment) on the basis of data received from an artificial satellite, the data including data having been received without being received via a base station 30 and data having been received via a base station 30. Therefore, in this case, the obtainment unit 13c may obtain correction information for PPP-RTK position determination generated for each of the predetermined areas, from the calculation apparatus 100.

Furthermore, the calculation apparatus 100 transmits correction information (for example, a list of correction information) for PPP-RTK position determination generated for each of the predetermined areas, to the terminal device 10, but the correction information may be directly transmitted to the terminal device 10 or the correction information may be transmitted to the terminal device 10 via an artificial satellite. Therefore, in a case where the PPP-RTK method is adopted also, the obtainment unit 13c may obtain correction information transmitted directly from the calculation apparatus 100 or may obtain correction information transmitted from the calculation apparatus 100 via an artificial satellite.

### Re Selection Unit 13d

For example, it is assumed that in a case where the PPP method is adopted, correction information generated for each of artificial satellites is obtained by the obtainment unit 13c. In this case, the selection unit 13d may detect an artificial satellite that is able to be detected from the position of the terminal device 10 and select correction information corresponding to the artificial satellite detected, from the correction information generated respectively for the artificial satellites.

For example, the selection unit 13d may detect, as an artificial satellite for which a process is to be executed, an artificial satellite that is moving in a predetermined range in the sky over the terminal device 10 and select correction information corresponding to this artificial satellite for which the process is to be executed, from the correction information generated respectively for the artificial satellites.

It is assumed that in a case where the PPP-RTK method is adopted, correction information generated for each of predetermined areas is obtained by the obtainment unit 13c. In this case, the selection unit 13d may detect an area including the position indicated by rough position information on the terminal device 10, the area being one of the predetermined areas, and select correction information corresponding to the area detected, from the correction information generated respectively for the predetermined areas.

The above described process described to be performed by the selection unit 13d may be performed by the correction unit 13e described below, for example. In this case, the terminal device 10 may have no selection unit 13d.

### Re Correction Unit 13e

The correction unit 13e calculates position information on the terminal device 10 on the basis of correction information obtained by the obtainment unit 13c.

For example, it is assumed that in a case where the PPP method is adopted, correction information generated for each of artificial satellites is obtained by the obtainment unit 13c, and correction information corresponding to an artificial satellite for which a process is to be executed is selected by the selection unit 13d from the correction information obtained. In this case, the correction unit 13e calculates position information on the terminal device 10 on the basis of the correction information selected, of the correction information generated respectively for the artificial satellites.

For example, by PPP position determination calculation using the correction information selected, the correction unit 13e calculates position information on the terminal device 10. More specifically, on the basis of the correction information selected and the rough position information calculated by the rough position calculation unit 13b, the correction unit 13e calculates corrected position information by performing PPP position determination calculation as correction calculation of correcting the rough position information.

It is assumed that in a case where the PPP-RTK method is adopted, correction information generated for each of predetermined areas is obtained by the obtainment unit 13c and correction information corresponding to the position indicated by the rough position information on the terminal device 10 is selected by the selection unit 13d from the correction information obtained. In this case, the correction unit 13e calculates position information on the terminal device 10 on the basis of the correction information selected, of the correction information generated respectively for the predetermined areas.

For example, by PPP-RTK position determination calculation using the correction information selected, the correction unit 13e calculates position information on the terminal device 10. More specifically, on the basis of the correction information selected and the rough position information calculated by the rough position calculation unit 13b, the correction unit 13e calculates corrected position information by performing PPP-RTK position determination calculation as correction calculation of correcting the rough position information.

The correction unit 13e may store corrected position information that is position information that has been corrected and obtained by the correction calculation, into the storage unit 12. Furthermore, the correction unit 13e may be a processing unit corresponding to a calculation unit.

### Re Transmission Unit 13f

The transmission unit 13f may transmit position information (corrected position information) calculated by the correction unit 13e. For example, the transmission unit 13f may transmit the corrected position information directly to the determination apparatus 200.

The transmission unit 13f may transmit the corrected position information to the calculation apparatus 100. In this case, the calculation apparatus 100 transmits this corrected position information to the determination apparatus 200. That is, the transmission unit 13f may transmit the corrected position information to the determination apparatus 200 via the calculation apparatus 100.

### 5-2. Configuration of Calculation Apparatus

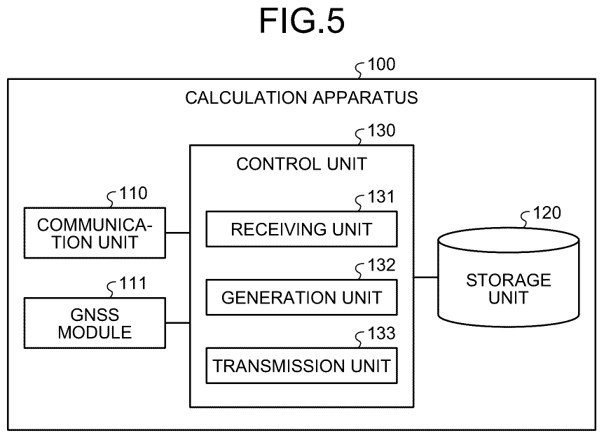

FIG. 5 is a diagram illustrating an example of a configuration of the calculation apparatus 100 according to the embodiment. The calculation apparatus 100 may include a communication unit 110, a GNSS module 111, a storage unit 120, and a control unit 130.

### Re Communication Unit 110

The communication unit 110 may be implemented by, for example, an NIC. The communication unit 110 may be connected to the network N by wire or wirelessly. The communication unit 110 may, for example, transmit and receive information to and from a terminal device 10, a base station 30, and the determination apparatus 200.

### Re GNSS Module 111

The GNSS module 111 receives a GNSS signal transmitted from an artificial satellite. The GNSS module 111 may include any component for receiving the GNSS signal.

Furthermore, the GNSS module 111 may be an antenna-integrated GNSS module that has been integrated with an antenna. However, the GNSS module 111 is not necessarily integrated with an antenna, and if not, the calculation apparatus 100 may have an antenna individually from the GNSS module 111. Furthermore, the antenna referred to herein may be a high performance antenna equivalent to, for example, a radar dome or a parabola antenna.

### Re Storage Unit 120

The storage unit 120 is implemented by, for example: a semiconductor memory element, such as a RAM or a flash memory; or a storage device, such as a hard disk or an optical disk. The storage unit 120 may store, for example, correction information generated by the generation unit 132.

### Re Control Unit 130

The control unit 130 may be implemented by various programs being executed by a CPU, a GPU, or an MPU, for example, with a RAM serving as a work area, the various programs having been stored in a storage device inside the calculation apparatus 100. Furthermore, the control unit 130 may be implemented by, for example, an integrated circuit, such as an ASIC or FPGA.

The control unit 130 may have a receiving unit 131, a generation unit 132, and a transmission unit 133. The internal configuration of the control unit 130 is not limited to the configuration illustrated in FIG. 5, and may be any other configuration that performs the information processing described later. Furthermore, the processing units included in the control unit 130 may have any other connective relations instead, without being limited to the connective relations illustrated in FIG. 5.

### Re Receiving Unit 131

The receiving unit 131 may receive a GNSS signal via the GNSS module 111.

For example, in a case where the PPP method is adopted, as described by reference to FIG. 2, the receiving unit 131 may receive a GNSS signal transmitted by an artificial satellite. For example, the receiving unit 131 may receive GNSS signals transmitted by plural artificial satellites.

In a case where the PPP-RTK method is adopted, as described by reference to FIG. 3, the receiving unit 131 may receive a GNSS signal transmitted by an artificial satellite via a base station 30. For example, the receiving unit 131 may receive GNSS signals transmitted by plural artificial satellites via a base station 30. That is, the receiving unit 131 may receive a GNSS signal transmitted from a base station 30, through reception of the GNSS signal transmitted by an artificial satellite by the base station 30.

On the basis of a terminal device 10, for example, the receiving unit 131 may select a base station 30 for which a process is to be executed, from base stations 30 installed at respective places. For example, the receiving unit 131 may select, as a base station 30 for which a process is to be executed, a base station 30 that is present in an area corresponding to a position indicated by rough position information on a terminal device 10. The receiving unit 131 may then transmit a distribution request to request distribution of a GNSS signal to the base station 30 selected and receive the GNSS signal transmitted from the base station 30 in response to the distribution request.

### Re Generation Unit 132

The generation unit 132 generates correction information on the basis of information based on a GNSS signal received by the receiving unit 131, that is, satellite data.

For example, in a case where the PPP method is adopted, the generation unit 132 obtains satellite data on the basis of a GNSS signal received from an artificial satellite. For example, in response to reception of GNSS signals transmitted by plural artificial satellites, the generation unit 132 obtains satellite data for each of these artificial satellites. The generation unit 132 may obtain the satellite data from only the GNSS signals received from the artificial satellites.

The generation unit 132 then generates correction information for PPP position determination by means of a calculation algorithm based on the satellite data obtained. Specifically, the generation unit 132 generates correction information for each of the plural artificial satellites by generating correction information corresponding to the artificial satellites by means of a calculation algorithm using the satellite data obtained on the basis of the GNSS signals received from the artificial satellites.

In a case where the PPP-RTK method is adopted, the generation unit 132 may, not only obtain satellite data on the basis of a GNSS signal received without being received via any base station 30, but also obtain satellite data from a GNSS signal from an artificial satellite received via a base station 30. More specifically, in response to reception of GNSS signals transmitted by plural artificial satellites, the generation unit 132 may obtain satellite data for each of the artificial satellites, and in response to reception of GNSS signals transmitted by plural artificial satellites via a base station 30, the generation unit 132 may obtain satellite data corresponding to this base station 30.

For example, in a case where plural base stations 30 are located at respective places, GNSS signals received by these base stations 30 may be respectively received from different artificial satellites. That is, not necessarily all of these base stations 30 receive their GNSS signals from an artificial satellite or artificial satellites common to the base stations 30. Therefore, for each of the base stations 30, for example, the generation unit 132 may obtain satellite data corresponding to that base station 30 on the basis of a GNSS signal received via that base station 30.

The generation unit 132 then generates correction information for PPP-RTK position determination by means of a calculation algorithm using satellite data obtained for each artificial satellite and satellite data obtained for each base station 30. For example, according to the calculation algorithm, the generation unit 132 generates correction information for each of the areas according to the embodiment on the basis of the satellite data obtained for each artificial satellite and the satellite data obtained for each base station 30.

The areas (predetermined areas) according to the embodiment may be areas that have been set beforehand by any method, or areas that have been generated beforehand by the generation unit 132 on the basis of, for example, the satellite orbit error, the satellite clock error, the ionospheric delay error, the tropospheric delay error, and the satellite signal bias.

The generation unit 132 may store the correction information generated, into the storage unit 120.

### Re Transmission Unit 133

The transmission unit 133 transmits correction information generated by the generation unit 132 to a terminal device 10. For example, the transmission unit 133 may transmit the correction information directly to the terminal device 10 or may transmit the correction information to the terminal device 10 via an artificial satellite.

For example, in a case where the PPP method is adopted, the transmission unit 133 may generate a list of correction information by gathering together correction information generated for each artificial satellite and transmit the list of correction information generated, to an artificial satellite so that the list is broadcasted to the terminal device 10.

In a case where the PPP-RTK method is adopted, the transmission unit 133 may generate a list of correction information by gathering together correction information generated for each of the areas according to the embodiment and transmit the list of correction information generated, to an artificial satellite so that the list is broadcasted to the terminal device 10.

The artificial satellite that has received the list of correction information transmits the list of correction information received, to the terminal device 10, in either the case of the PPP method or the case of the PPP-RTK method.

In the examples described thus far, the calculation apparatus 100 generates correction information (correction information for each artificial satellite or correction information for each area) and transmits the correction information to a terminal device 10-x and the terminal device 10 selects the correction information needed for correction calculation. However, this configuration is not necessarily adopted in the route determination process according to the embodiment.

For example, the calculation apparatus 100 may select the correction information needed for correction calculation and in this case, the calculation apparatus 100 may transmit the correction information selected, to the terminal device 10. This point will be described more specifically.

For example, the calculation apparatus 100 may further have a rough position information obtainment unit 134 that obtains rough position information calculated by a rough position calculation unit 13b of a terminal device 10. In this case, the terminal device 10 may transmit the rough position information calculated, to the calculation apparatus. Furthermore, the calculation apparatus 100 may further have a selection unit 135 serving as a processing unit corresponding to a selection unit 13d of the terminal device 10.

In a case where the PPP method is adopted, the selection unit 135 may determine, on the basis of the rough position information obtained by the rough position information obtainment unit 134, an artificial satellite that is able to be detected from the position of the terminal device 10 that has transmitted the rough position information and may select, from correction information generated for each artificial satellite, correction information corresponding to the artificial satellite determined.

Furthermore, in a case where the PPP-RTK method is adopted, the selection unit 135 may detect an area including the position indicated by the rough position information on the terminal device 10 that has transmitted the rough position information, the area being one of predetermined areas, and may select, from correction information generated for each of the predetermined areas, correction information corresponding to the area detected.

The transmission unit 133 then transmits the correction information selected by the selection unit 135, to the terminal device 10.

The rough position information obtainment unit 134 and the selection unit 135 may be configured as modules that are able to be combined with the calculation apparatus 100, for example, so that a configuration in which the calculation apparatus 100 selects correction information needed for correction calculation is able to be adopted depending on the situation.

### 5-3. Configuration of Determination Apparatus

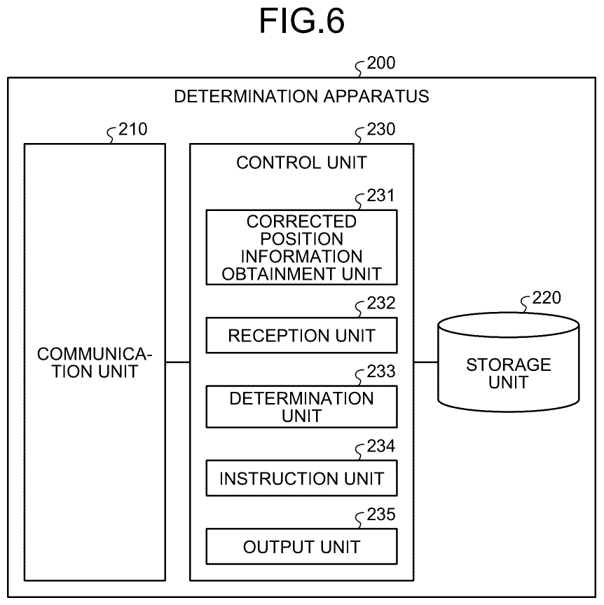

FIG. 6 is a diagram illustrating an example of a configuration of the determination apparatus 200 according to the embodiment. The determination apparatus 200 may have a communication unit 210, a storage unit 220, and a control unit 230.

### Re Communication Unit 210

The communication unit 210 may be implemented by, for example, an NIC. The communication unit 210 may be connected to the network N by wire or wirelessly. The communication unit 210 may transmit and receive information to and from a terminal device 10 and the calculation apparatus 100, via the network N, for example.

### Re Storage Unit 220

The storage unit 220 is implemented by, for example: a semiconductor memory element, such as a RAM or a flash memory; or a storage device, such as a hard disk or an optical disk. The storage unit 220 may store, for example, corrected position information obtained by a corrected position information obtainment unit 231 and route information indicating a movement route determined by the determination unit 233.

### Re Control Unit 230

The control unit 230 may be implemented by various programs (for example, a route determination program according to an embodiment) being executed by a CPU, a GPU, or an MPU, for example, with a RAM serving as a work area, the various programs having been stored in a storage device inside the determination apparatus 200. Furthermore, the control unit 230 may be implemented by, for example, an integrated circuit, such as an ASIC or FPGA.

The control unit 230 may have the corrected position information obtainment unit 231, a reception unit 232, a determination unit 233, an instruction unit 234, and an output unit 235. The internal configuration of the control unit 230 is not limited to the configuration illustrated in FIG. 6, and may be any other configuration that performs the information processing described later. Furthermore, the processing units included in the control unit 230 may have any other connective relations instead, without being limited to the connective relations illustrated in FIG. 6.

### Re Corrected Position Information Obtainment Unit 231

The corrected position information obtainment unit 231 may obtain position information on a terminal device 10 installed at any place serving as a reference of a route of a mobile object. The corrected position information obtainment unit 231 may obtain corrected position information that is position information calculated through correction calculation by the correction unit 13e. Furthermore, the corrected position information obtainment unit 231 may obtain corrected position information transmitted by the transmission unit 13f.

### Re Reception Unit 232

The reception unit 232 may receive definition information defining a movement route, from a user. For example, the reception unit 232 may receive the definition information via the application AP. FIG. 2 (and similarly FIG. 3) illustrates an example of a case where the reception unit 232 receives definition information from the user U1.

For example, in a state where a predetermined terminal device 10-x of terminal devices 10-x is to be used, the reception unit 232 may receive definition information defining a target point (for example, a start target or an arrival target) where a mobile object 60 is caused to arrive. For example, in a case where a ‘straight line mode’ for setting a straight-lined movement path has been selected in the application AP, the reception unit 232 may receive definition information defining at least two target points (for example, a start target and an arrival target) where the mobile object 60 is caused to arrive. That is, the user may cause the mobile object 60 to move on a straight line joining the target points.

Furthermore, in a state where a predetermined terminal device 10-x of terminal devices 10-x is to be used, the reception unit 232 may receive definition information defining a planar area where the mobile object 60 is caused to move in a space where the mobile object 60 is able to move. For example, the reception unit 232 may receive definition information defining vertex points at vertices of the planar area. For example, in a case where a ‘planar mode’ that is a mode for generating a planar area has been selected in the application AP, the reception unit 232 may receive definition information defining vertex points at vertices of the planar area. That is, the user may cause the mobile object 60 to move in the planar area.

Furthermore, in a state where a predetermined terminal device 10-x of terminal devices 10-x is to be used, the reception unit 232 may receive definition information defining vertex points at vertices of a three-dimensional area in a space. For example, in a case where a ‘three-dimensional mode’ that is a mode for generating a three-dimensional area has been selected in the application AP, the reception unit 232 may receive definition information defining vertex points at vertices of the three-dimensional area. That is, the user may cause the mobile object 60 to move in the three-dimensional area.

With respect to the above described example, the ‘straight line mode’, ‘planar mode’, and ‘three-dimensional mode’ have been described separately as modes for inputting definition information in the application AP, but modes in the application AP are not limited to them. For example, the application AP may enable input of definition information on a straight lined movement route, a planar area, and a three-dimension area, in a single mode. That is, the reception unit 232 may receive definition information including any of a definition of at least two target points, a definition of vertices of a planar area, and a definition of vertices of a three-dimensional area. That is, the user may input definition information in the application AP, the definition information being for causing the mobile object 60 to move in any way in a space where the mobile object 60 is movable. For example, the user may input definition information corresponding to movement of the mobile object 60 in the application AP as appropriate, the movement being for example, straight-lined movement from a target point to another target point, three-dimensional movement in a space, or horizontal movement in a plane.

### Re Determination Unit 233

On the basis of position information calculated by the correction unit 13e, the determination unit 233 determines a movement route for a mobile object. That is, on the basis of position information obtained by the corrected position information obtainment unit 231, the determination unit 233 may determine a movement route for a mobile object. Specifically, the determination unit 233 may determine a movement route for a mobile object 60 on the basis of corrected position information obtained by the corrected position information obtainment unit 231 and definition information received by the reception unit 232.

For example, in a case where definition information defining a target point has been received by the reception unit 232, the determination unit 233 may determine a movement route for a mobile object on the basis of corrected position information corresponding to a terminal device 10-x to be used and the definition information.

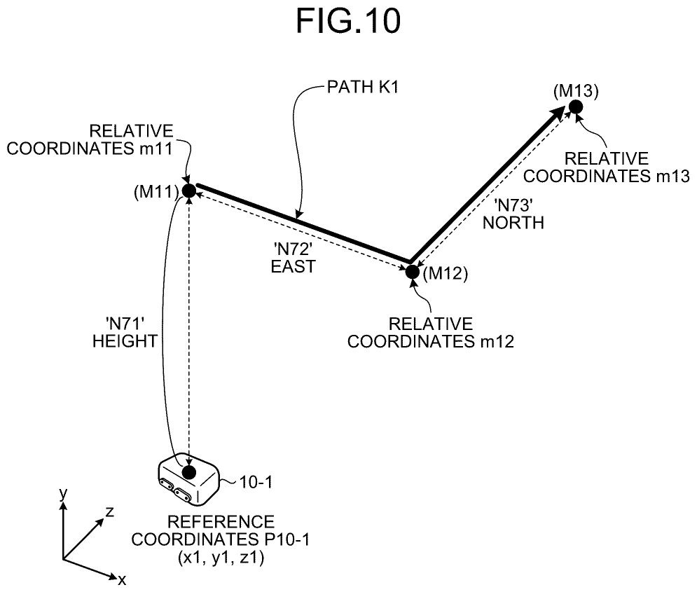

For example, in the following described case, definition information defining a target point is received in a state where one terminal device 10-x is to be used. In this case, the determination unit 233 may calculate, as the position of the target point, a relative position with reference to a position indicated by corrected position information corresponding to that one terminal device 10-x, the relative position satisfying the definition information. The determination unit 233 may determine, as a movement route, for example, a path through which the mobile object 60 is caused to move, with the calculated position being the target point. Details thereof will be described later by use of FIG. 10.

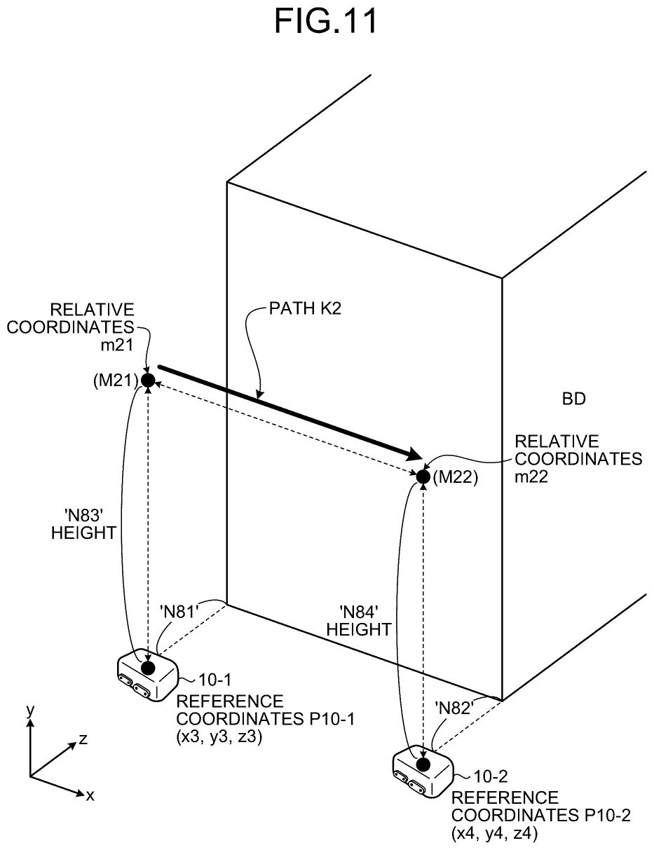

Furthermore, in the following described case, definition information defining target points is received in a state where two terminal devices 10-x are to be used, the target points being a start point corresponding to one of the two terminal devices 10-x and an arrival point corresponding to the other one of the two terminal devices 10-x. In this case, the determination unit 233 may calculate, as the positions of the target points, relative positions with reference to positions indicated by corrected position information corresponding to these terminal devices, the relative positions satisfying the definition information. The determination unit 233 may, for example, determine a movement route that is a path through which a mobile object 60 is caused to move toward the position corresponding to the arrival point from the position corresponding to the start point, these positions being of the positions calculated. Details thereof will be described later by use of FIG. 11.

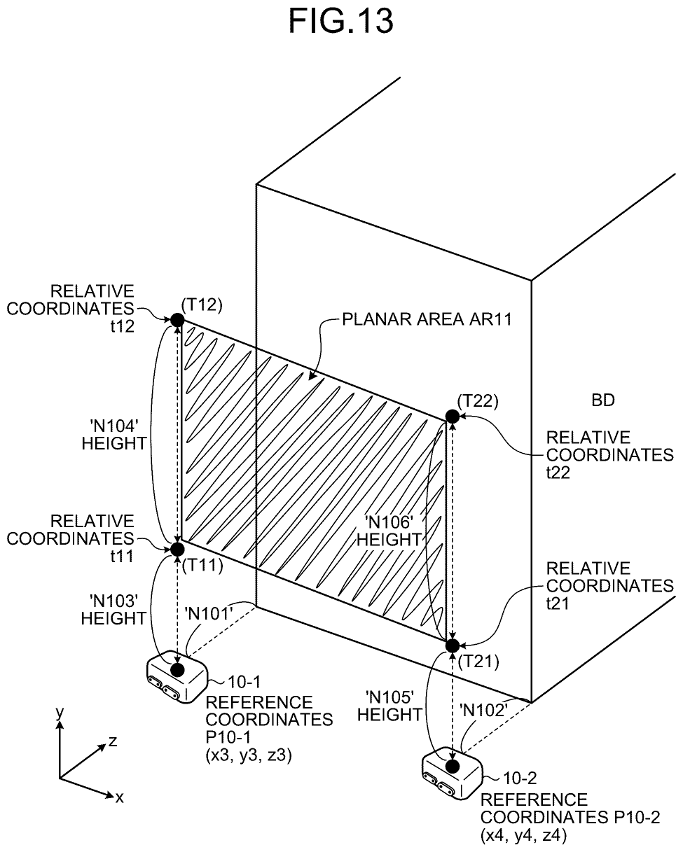

Furthermore, in the following described case, definition information defining vertex points at vertices of a planar area is received. In this case, the determination unit 233 may generate, for example, the planar area satisfying the definition information, on the basis of corrected position information corresponding to a terminal device 10-x that is to be used at that time. The determination unit 233 may, for example, determine a movement route for a mobile object 60 on the basis of the planar area generated. For example, the determination unit 233 may calculate vertex points that are relative positions with reference to a position indicated by the corrected position information corresponding to the terminal device 10-x to be used, the relative positions satisfying the definition information. The determination unit 233 may generate a planar area having, as its vertices, the calculated vertex points. Furthermore, the determination unit 233 may determine, according to the definition information, a movement route that is a path through which the mobile object 60 is caused to move in the generated planar area. Details thereof will be described later by use of FIG. 13.

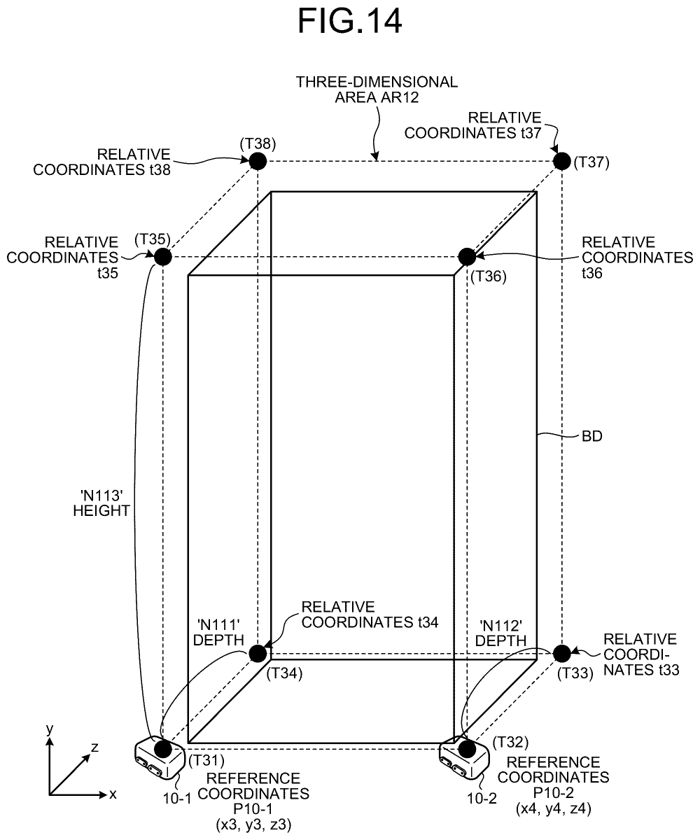

Furthermore, in the following described case, definition information defining vertex points at vertices of a three-dimensional area is received. In this case, by generating, on the basis of corrected position information corresponding to at least two terminal devices 10-x to be used at that time, a three-dimensional area satisfying the definition information, the determination unit 233 may determine a movement route for a mobile object 60 on the basis of the three-dimensional area generated. For example, the determination unit 233 may calculate, as vertex points, relative positions with reference to positions indicated by corrected position information corresponding to two terminal device 10-x to be used, the relative positions satisfying the definition information. The determination unit 233 may, for example, generate a three-dimensional area having, as its vertices, the calculated vertex points. Furthermore, the determination unit 233 may determine, according to the definition information, a movement route that is a path through which a mobile object 60 is caused to move in a predetermined planar area of planar areas forming the generated three-dimensional area. Furthermore, the determination unit 233 may generate, according to the definition information, a movement route that is a path through which a mobile object 60 is caused to move inside the three-dimensional area so that the mobile object 60 does not exit the three-dimensional area. Furthermore, the determination unit 233 may determine, according to the definition information, a movement route that is a path through which a mobile object 60 is caused to move outside the three-dimensional area so that the mobile object 60 does not enter the three-dimensional area. Details thereof will be described later by use of FIG. 14 to FIG. 19.

Furthermore, the determination unit 233 may store route information indicating the movement route determined, into the storage unit 220.

### Re Instruction Unit 234

The instruction unit 234 may instruct a mobile object 60, for which a process is to be executed, to move through a movement route determined by the determination unit 233. That is, for example, the instruction unit 234 may transmit route information indicating the movement route determined by the determination unit 233, to the mobile object 60.

### Re Output Unit 235

The output unit 235 may output predetermined information to a user of a mobile object 60, for which a process is to be executed, on the basis of whether or not the mobile object 60 is moving through a route determined by the determination unit 233. For example, in a case where it has been determined that a mobile object 60, for which a process is to be executed, is moving, deviated from a movement route determined by the determination unit 233, the output unit 235 may output information indicating that the mobile object 60 has deviated from the movement route.

### 5-4. Configuration of Mobile Device

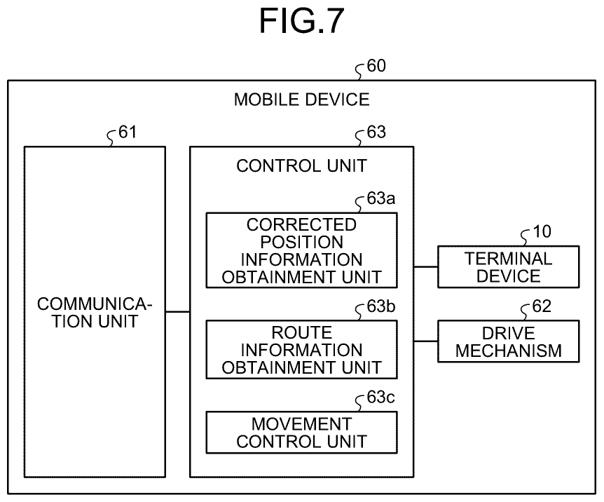

FIG. 7 is a diagram illustrating an example of a configuration of a mobile device 60 according to the embodiment. The mobile device 60 may have a terminal device 10, a communication unit 61, a drive mechanism 62, and a control unit 63. The mobile device 60 may also have a predetermined imaging means that is not illustrated in FIG. 7.

### Re Terminal Device 10

The terminal device 10 described by reference to FIG. 4 may be installed as a position determination module in the mobile object 60.

### Re Communication Unit 61

The communication unit 61 may be implemented by, for example, an NIC. The communication unit 61 may be connected to the network N by wire or wirelessly. The communication unit 61 may transmit and receive information to and from a user device T, such as a smartphone used by a user, and the determination apparatus 200, via the network N, for example. Instead of the communication unit 11 of the terminal device 10, the communication unit 61 may transmit and receive information to and from the calculation apparatus 100 and the determination apparatus 200.

### Re Drive Mechanism 62

The drive mechanism 62 may be a control mechanism for causing the mobile object 60 to operate. For example, the drive mechanism 62 may include a motor, an engine, a propeller, and a controller.

### Re Control Unit 63

The control unit 63 may be implemented by various programs being executed by a CPU, a GPU, or an MPU, for example, with a RAM serving as a work area, the various programs having been stored in a storage device inside the mobile device 60. Furthermore, the control unit 63 may be implemented by, for example, an integrated circuit, such as an ASIC or FPGA.

The control unit 63 may have a corrected position information obtainment unit 63a, a route information obtainment unit 63b, and a movement control unit 63c. The internal configuration of the control unit 63 is not limited to the configuration illustrated in FIG. 7, and may be any other configuration configured to execute information processing described later. Furthermore, the processing units included in the control unit 63 may have any other connective relations, without being limited to the connective relations illustrated in FIG. 7.

### Re Corrected Position Information Obtainment Unit 63a

The corrected position information obtainment unit 63a may obtain corrected position information obtained by PPP calculation (or PPP-RTK calculation) by the correction unit 13e of the terminal device 10.

### Re Route Information Obtainment Unit 63b

The route information obtainment unit 63b may obtain route information transmitted from the instruction unit 234 of the determination apparatus 200.

### Re Movement Control Unit 63c

The movement control unit 63c is capable of controlling movement of the mobile object 60. For example, the movement control unit 63c may control movement of the mobile object 60 on the basis of route information obtained by the route information obtainment unit 63b. For example, on the basis of corrected position information obtained by the corrected position information obtainment unit 63a and the route information obtained by the route information obtainment unit 63b, the movement control unit 63c may control movement of the mobile object 60. For example, while comparing the current position indicated by the latest corrected position information with a position on a path indicated by the route information obtained, the movement control unit 65c may control movement of the mobile object 60 so that the mobile object 60 moves toward a target point, while making adjustment so that the mobile object 60 does not deviate from the position on the path.

### First Embodiment

### 1. Re Route Determination Process

The points common to the first embodiment and second embodiment have been described thus far by use of FIG. 1 to FIG. 7. Examples of these embodiments will be described more specifically hereinafter. Firstly, specific examples of the first embodiment will be described by use of FIG. 8 and FIG. 9. As described above, a scene where the route determination process according to the embodiment is applied will be described with respect to the first embodiment, with a particular focus on a route determination process for marine vessels and a route determination process for autonomous driving cars.

### 1-1. Route Determination Process (1)

Because the PPP method is suitable for the field of marine vessels, in the following example of a route determination process described by reference to FIG. 8, a movement route for a marine vessel is determined by utilization of a position determination result by PPP position determination. Specifically, in the following example of a procedure of the route determination process described by reference to FIG. 8, a movement route for a marine vessel is determined by utilization of a result of position determination through PPP position determination. FIG. 8 is a first diagram illustrating an example of the route determination process according to the first embodiment.

Furthermore, FIG. 8 illustrates the route determination process described by reference to FIG. 2 in more detail. That is, in the example of FIG. 8, it is assumed that a user U1 wants to cause a mobile object 60 (for example, a tanker) currently stopping at a predetermined position in an ocean area to move to a destination on a shore LA5 from the current position and cause the mobile object 60 to land the shore at the destination. In this case, the user U1 may, as illustrated in FIG. 8, install one terminal device 10-1 of two terminal devices 10-x at the destination on the shore LA5 and the other one terminal device 10-2 of the two terminal devices 10-x at the mobile object 60 itself.

Furthermore, in the example of FIG. 8, there are satellites SAx in the sky over the ocean area. Specifically, FIG. 8 illustrates an example where a satellite SA1, a satellite SA2, a satellite SA3, and a satellite SA4 (satellites SA1 to SA4) are present in the sky over the ocean area as satellites SAx, from which the calculation apparatus 100 is able to receive radio waves. That is, the satellites SAx are not necessarily present in the sky over the ocean area as long as the calculation apparatus 100 is able to receive radio waves from the satellites SAx.

In this state, the calculation apparatus 100 is able to generate correction information according to the following procedure and transmit the correction information generated, to the terminal device 10-1 and the terminal device 10-2.

The satellites SA1 to SA4 are respectively transmitting GNSS signals in this state. Therefore, the receiving unit 131 of the calculation apparatus 100 receives the GNSS signals transmitted respectively by the satellites SA1 to SA4.

Furthermore, in response to reception of the GNSS signals by the receiving unit 131, the generation unit 132 of the calculation apparatus 100 obtains, for each of the satellites SAx, satellite data that are information based on the GNSS signal received (Step S82). In the example of FIG. 8, it is assumed that the generation unit 132 has obtained, on the basis of the GNSS signal received from the satellite SA1, satellite data DA11 that are the satellite data corresponding to the satellite SA1, and has obtained, on the basis of the GNSS signal received from the satellite SA2, satellite data DA12 that are the satellite data corresponding to the satellite SA2. Furthermore, in the example of FIG. 8, it is assumed that the generation unit 132 has obtained, on the basis of the GNSS signal received from the satellite SA3, satellite data DA13 that are the satellite data corresponding to the satellite SA3, and has obtained, on the basis of the GNSS signal received from the satellite SA4, satellite data DA14 that are the satellite data corresponding to the satellite SA4.

Subsequently, by means of a calculation algorithm using the satellite data obtained at Step S82, the generation unit 132 generates, for each of the satellites SA1 to SA4, correction information for PPP position determination (Step S83).

Specifically, by means of a calculation algorithm based on the satellite data DA11, the generation unit 132 generates the correction information corresponding to the satellite SA1. FIG. 8 illustrates an example where the generation unit 132 has generated correction information C1 as the correction information corresponding to the satellite SA1. Furthermore, by means of a calculation algorithm based on the satellite data DA12, the generation unit 132 generates the correction information corresponding to the satellite SA2. FIG. 8 illustrates the example where the generation unit 132 has generated correction information C2 as the correction information corresponding to the satellite SA2.

Furthermore, by means of a calculation algorithm based on the satellite data DA13, the generation unit 132 generates the correction information corresponding to the satellite SA3. FIG. 8 illustrates the example where the generation unit 132 has generated correction information C3 as the correction information corresponding to the satellite SA3. Similarly, by means of a calculation algorithm based on the satellite data DA14, the generation unit 132 generates the correction information corresponding to the satellite SA4. FIG. 8 illustrates the example where the generation unit 132 has generated correction information C4 as the correction information corresponding to the satellite SA4.

Subsequently, the transmission unit 133 of the calculation apparatus 100 transmits the correction information generated by the generation unit 132 to each of the terminal device 10-1 and the terminal device 10-2. For example, the transmission unit 133 may transmit the correction information to each of the terminal device 10-1 and the terminal device 10-2 via the satellites SAx. For example, the transmission unit 133 may distribute the correction information to the satellites SAx so that the correction information generated by the generation unit 132 is broadcasted to each of the terminal device 10-1 and the terminal device 10-2.

More specifically, by gathering together the correction information generated for each of the satellites SA1 to SA4, the transmission unit 133 may generate a list of the correction information and transmit the generated list of the correction information to the satellites SAx so that the generated list of the correction information is broadcasted to each of the terminal device 10-1 and the terminal device 10-2. FIG. 8 illustrates the example where the transmission unit 133 generates a correction information list L1 as the list of the correction information and transmits the generated correction information list L1 to each of the terminal device 10-1 and the terminal device 10-2 via the satellites SAx.

The process of generating the list of correction information may be performed by, for example, the generation unit 132, instead of the transmission unit 133.

Subsequently, in response to obtainment of the correction information list L1 by the obtainment unit 13c, the selection unit 13d of each of the terminal device 10-1 and the terminal device 10-2 detects, as a satellite SAx for which a process is to be executed, a satellite SAx (that is, a satellite SAx that is able to be detected from that terminal device) that is moving in a predetermined range in the sky over that terminal device, and thereby selects correction information corresponding to the detected satellite SAx, from the correction information list L1 (Step S85).

The correction unit 13e then executes calculation for correcting its position information on the basis of the correction information selected by the selection unit 13d (Step S86). For example, by correcting its rough position information through PPP calculation using the correction information, the correction unit 13e may calculated corrected position information. This position information calculated is position information that is more accurate than the rough position information.

Through Step S85 to Step S86, if the selection unit 13d of the terminal device 10-1 detects the satellite SA4 as the satellite SAx for which a process is to be executed, the selection unit 13d is able to select the correction information corresponding to the satellite SA4, from the four sets of correction information included in the correction information list L1. Furthermore, through Step S85 to Step S86, if the selection unit 13d of the terminal device 10-2 detects the satellite SA3 as the satellite SAx for which a process is to be executed, the selection unit 13d is able to select the correction information corresponding to the satellite SA3, from the four sets of correction information included in the correction information list L1.

Subsequently, the transmission unit 13f of each of the terminal device 10-1 and the terminal device 10-2 transmits the corrected position information calculated by the correction unit 13e, to the determination apparatus 200 (Step S87). In this case, the corrected position information obtainment unit 231 of the determination apparatus 200 obtains the corrected position information from each of the terminal device 10-1 and the terminal device 10-2.

FIG. 8 illustrates the example where the same step number has been assigned to the process performed by the terminal device 10-1 and the process performed by the terminal device 10-2 and both of these processes are performed at the same time. However, because the terminal device 10-1 and the terminal device 10-2 may be activated at different times, their processes illustrated in FIG. 8 may be performed individually depending on these times.

The process described thus far enables the determination apparatus 200 to know accurate position information on each of the terminal device 10-1 and the terminal device 10-2, the accurate position information having been obtained by the PPP method. In a case where the determination apparatus 200 has already obtained the accurate position information on each of the terminal device 10-1 and the terminal device 10-2 as described above, the user U1 is able to input definition information to the determination apparatus 200, the definition information defining a mode of movement, the mode indicating a route through which a mobile object 60 is caused to move.

In the example of FIG. 8, in a state where the terminal devices 10-1 and 10-2 are to be used, the user U1 inputs definition information to the determination apparatus 200, the definition information defining a movement route with these terminal devices being the points of origin. In the example of FIG. 8, for example, the user U1 is able to define target points with reference to the terminal device 10-2. For example, the user U1 inputs definition information to the determination apparatus 200, the definition information defining the target points (target points joining between a start target and an arrival target) on the movement route by use of directions and distances, like “‘a point (current location point of the mobile object 60) where the terminal device 10-2 is currently positioned’ (start target point M81), ‘a point 10 km north (corresponding to N81)’ of the target point 81 (relay target point M82), and ‘a point (point on the shore LA5) where the terminal device 10-1 is currently positioned’ from the target point M82 (arrival target point M83)”. Furthermore, in this case, the reception unit 232 of the determination apparatus 200 receives this definition information (Step S88).

In response to the reception unit 232 receiving the definition information, the determination unit 233 of the determination apparatus 200 executes a route determination process for determining a movement route for the mobile object 60 on the basis of this definition information and the corrected position information on the terminal device 10-1 or the terminal device 10-2 (Step S89). For example, the determination unit 233 may determine a movement route for the mobile object 60, the movement route being a route including a relative position with reference to a position indicated by the corrected position information, the relative position satisfying the definition information.

For example, the determination unit 233 may calculate, as the position of the target point M82, a relative position with reference to a position (reference coordinates m81) indicated by the corrected position information corresponding to the terminal device 10-2, the relative position satisfying “‘a point 10 km north’ of the terminal device 10-2”. For example, by calculating the relative coordinates m82 on the basis of the reference coordinates m81 and ‘10 km’ north, the determination unit 233 may determine the relative coordinates m82 as the position of the target point M82.

Furthermore, the determination unit 233 may determine, as a movement route, a path K8 that is a combination of a straight line path having a vector directed from the target point M81 to the target point M82 and a straight line path having a vector directed from the target point M82 to the target point M83, the path K8 being straight-lined. By inputting route information indicating the path K8 to the mobile object 60, the instruction unit 234 may instruct the mobile object 60 to move in a straight line via the target point 82 from a target point M11 (start target) to the target point M83 (arrival target).

In another example, the user U1 may define target points with reference to the terminal device 10-1. For example, the user U1 may input definition information to the determination apparatus 200, the definition information defining target points on a movement route using directions and distances, like “‘a point (point on the shore LA5) where the terminal device 10-1 is currently positioned’ (arrival target point M83), ‘a point 20 km west (corresponding to N83)” of the target point M83 (relay target point M82), and ‘a point (current location point of the mobile object 60) where the terminal device 10-2 is currently positioned’ from the target point M82 (the start target point M81)”.

In this case, the determination unit 233 may calculate, as the position of the target point M82, a relative position with reference to a position (reference coordinates m83) indicated by the corrected position information corresponding to the terminal device 10-1, the relative position satisfying “‘a point 20 km west’ of the terminal device 10-1”. For example, by calculating the relative coordinates m82 on the basis of the reference coordinates m83 and ‘20 km’ west, the determination unit 233 may determine the relative coordinates m82 as the position of the target point M82.

Furthermore, the determination unit 233 may determine, as a movement route, a path K8 that is a combination of a straight line path having a vector directed from the target point M81 to the target point M82 and a straight line path having a vector directed from the target point M82 to the target point M83, the path K8 being straight-lined. By inputting route information indicating the path K8 to the mobile object 60, the instruction unit 234 may instruct the mobile object 60 to move in a straight line via the target point 82 from the target point M81 (start target) to the target point M83 (arrival target).

### 1-2. Route Determination Process (2)

Because the PPP-RTK method is suitable for the field of autonomous driving cars, in an example of a route determination process described next by reference to FIG. 9, a movement route for an autonomous driving car is determined by utilization of a result of position determination by PPP-RTK position determination. Specifically, an example of a procedure of a route determination process, in which a movement route for an autonomous driving car is determined by utilization of a result of position determination through PPP-RTK position determination, will be described by reference to FIG. 9. FIG. 9 is a second diagram illustrating an example of the route determination process according to the first embodiment.

Furthermore, FIG. 9 illustrates the route determination process described by reference to FIG. 3 in more detail. That is, in the example of FIG. 9, it is assumed that a user U1 wants to move a mobile object 60 (for example, an on-demand automobile) currently stopping on a road to a destination on a road from the current location. In this case, the user U1 may, as illustrated in FIG. 9, install one terminal device 10-1 of two terminal devices 10-x at the destination present on the road and the other terminal device 10-2 of the two terminal devices 10-x at the mobile object 60 itself.

Furthermore, the areas according to the embodiment have been described by reference to FIG. 3, but with respect to the example in FIG. 9, the route determination process will be described for, for example, a situation where four areas AR1, AR2, AR3, and AR4 (areas AR1 to AR4) have been set as the areas according to the embodiment. The areas AR to AR4 do not necessarily have the same shape and size, and may have different shapes and sizes depending on the situation. For example, as described by reference to FIG. 3, the areas according to the embodiment may be set on the basis of information related to errors, and may thus have shapes and sizes different from one another depending on the statuses of the errors.

In response to setting of the areas according to the embodiment, the calculation apparatus 100 may have information related to the set areas. In the example of FIG. 9, the calculation apparatus 100 may have, for example, position information indicating respective positions of the areas AR1 to AR4.

Furthermore, as described by reference to FIG. 3, a base station 30 is not necessarily located in each of the areas according to the embodiment, and in a case where a base station 30 is located in any area, the number of base stations 30 located in that area is not limited. That is, the areas according to the embodiment may include an area where no base station 30 is located, an area where only one base station 30 is located, and/or an area where plural base stations 30 are located. On the basis of this example, FIG. 9 illustrates the example in which a base station 30-1 is installed in the area AR1, a base station 30-2 is installed in the area AR2, and a base station 30-4 is installed in the area AR4. However, in the example of FIG. 9, no base station 30 is installed in the area AR3.

Furthermore, in the example of FIG. 9, there are satellites SAx in the sky over these areas. Specifically, FIG. 9 illustrates the example where a satellite SA1, a satellite SA2, a satellite SA3, and a satellite SA4 (satellites SA1 to SA4) are present in the sky over the areas AR1 to AR4 as satellites SAx, from which the calculation apparatus 100 is able to receive radio waves. That is, the satellites SAx are not necessarily present in the sky over the areas AR1 to AR4 as long as the calculation apparatus 100 is able to receive radio waves from the satellites SAx.

In this state, the calculation apparatus 100 is able to generate correction information according to the following procedure and transmit the correction information generated, to the terminal device 10-1 and the terminal device 10-2.

The satellites SA1 to SA4 are respectively transmitting GNSS signals in this state. In this case, the receiving unit 131 of the calculation apparatus 100 receives the GNSS signals transmitted by the satellites SAx (Step S91), but may receive the GNSS signals through two different routes (Step S91-1 and Step S91-2) at this Step S91. For example, as illustrated in FIG. 9, the receiving unit 131 receives the GNSS signals from the satellites SAx in one of the routes (Step S91-1). In the example of FIG. 9, the receiving unit 131 receives the GNSS signals transmitted respectively by the satellites SA1 to SA4.

Furthermore, the receiving unit 131 receives the GNSS signals via the base stations 30 through the other one of the routes (Step S91-2). At Step S91-2, the base stations 30 receive the GNSS signals from the satellites SAx (Step S31-2a). As to this point, FIG. 9 illustrates the example in which the base station 30-1 located in the area AR1 receives the GNSS signal transmitted by the satellite SA1, the base station 30-2 located in the area AR2 receives the GNSS signals transmitted by the satellites SA2 and SA3, and the base station 30-4 located in the area AR4 receives the GNSS signal transmitted by the satellite SA4.

Furthermore, the base stations 30 may be constantly receiving GNSS signals and transmit the GNSS signals received, to the calculation apparatus 100 (Step S91-2b). The example in FIG. 9 represents the example where the base station 30-1 transmits the GNSS signal received from the satellite SA1 to the calculation apparatus 100, the base station 30-2 transmits the GNSS signals received from the satellites SA and SA3 to the calculation apparatus 100, and the base station 30-4 transmits the GNSS signal received from the satellite SA4 to the calculation apparatus 100. As a result, the receiving unit 131 receives the GNSS signals via the base stations 30.

At Step S91-2b, the base stations 30 may transmit, together with the GNSS signals, information indicating known coordinates of their own, to the calculation apparatus 100. Specifically, the base station 30-1 transmits information on known coordinates of its own to the calculation apparatus 100 and the base station 30-2 transmits information on known coordinates of its own to the calculation apparatus 100. Furthermore, the base station 30-3 transmits information on known coordinates of its own to the calculation apparatus 100 and the base station 30-4 transmits information on known coordinates of its own to the calculation apparatus 100.

Furthermore, in response to reception of the GNSS signals by the receiving unit 131, the generation unit 132 obtains information based on the GNSS signals received (Step S92).

For example, for each of the satellites SAx, the generation unit 132 may obtain, as information based on the GNSS signal, satellite data based on the GNSS signal received from that satellite SAx at Step S91-1.

In the example of FIG. 9, it is assumed that the generation unit 132 has obtained, on the basis of the GNSS signal received directly from the satellite SA1, satellite data DA11 that are the satellite data corresponding to the satellite SA1, and has obtained, on the basis of the GNSS signal received directly from the satellite SA2, satellite data DA12 that are the satellite data corresponding to the satellite SA2. Furthermore, in the example of FIG. 9, it is assumed that the generation unit 132 has obtained, on the basis of the GNSS signal received directly from the satellite SA3, satellite data DA13 that are the satellite data corresponding to the satellite SA3, and has obtained, on the basis of the GNSS signal received directly from the satellite SA4, satellite data DA14 that are the satellite data corresponding to the satellite SA4.

The generation unit 132 may obtain, for each of the base stations 30 located in the respective areas, as the information based on the GNSS signal, base station data based on the GNSS signal received via that base station 30 at Step S91-2. For example, the generation unit 132 may obtain, as the base station data: satellite data based on the GNSS signals received via the respective base stations 30 located in the areas at Step S91-2; and information on the known coordinates transmitted with the GNSS signals.

As to this point, in the example of FIG. 9, the generation unit 132 obtains, on the basis of the GNSS signal received via the base station 30-1 located in the area AR1, base station data including the satellite data corresponding to the base station 30-1 and information indicating the known coordinates of the base station 30-1. As to this point, in the example of FIG. 9, assuming that the generation unit 132 has obtained base station data DA21, the base station data DA21 may include the satellite data corresponding to the base station 30-1 and the information indicating the known coordinates of the base station 30-1.

Furthermore, in the example of FIG. 9, the generation unit 132 obtains, on the basis of the GNSS signal received via the base station 30-2 located in the area AR2, base station data including the satellite data corresponding to the base station 30-2 and information indicating the known coordinates of the base station 30-2. As to this point, it is assumed that in the example of FIG. 9, the generation unit 132 has obtained base station data DA22 (DA22-1 and DA22-2). In this case, the base station data DA22-1 may include the satellite data based on the GNSS signal from the satellite SA2 of the GNSS signals received via the base station 30-2, and information indicating the known coordinates of the base station 30-2. The base station data DA22-2 may include the satellite data based on the GNSS signal from the satellite SA3 of the GNSS signals received via the base station 30-2, and information indicating the known coordinates of the base station 30-2.

Furthermore, in the example of FIG. 9, the generation unit 132 obtains, on the basis of the GNSS signal received via the base station 30-4 located in the area AR4, base station data including the satellite data corresponding to the base station 30-4 and information indicating the known coordinates of the base station 30-4. As to this point, in the example of FIG. 9, assuming that the generation unit 132 has obtained base station data DA24, the base station data DA24 may include the satellite data corresponding to the base station 30-4 and the information indicating the known coordinates of the base station 30-4.

Subsequently, the generation unit 132 generates, by means of a calculation algorithm using the satellite data and base station data obtained at Step S92, correction information for PPP-RTK position determination, for each of the areas AR1 to AR4 that are the areas according to the embodiment (Step S93). For example, on the basis of the satellite data obtained at Step S92, and the base station data obtained at Step S92, the generation unit 132 may generate the correction information for each of the areas AR1 to AR4.

For example, by using a calculation algorithm according to how the base stations 30 are located in the areas according to the embodiment, the generation unit 132 may generate the correction information for each of the areas according to the embodiment. Through this calculation algorithm, the generation unit 132 may generate the correction information for each of the areas by the following method.

For example, for the area AR1 where the base station 30-1 is located, the generation unit 132 may generate the correction information corresponding to the area AR1 on the basis of the satellite data (that is, the satellite data DA11 to DA14) obtained respectively for the satellites SAx and the base station data DA21 obtained for the base station 30-1. In the example of FIG. 9, the base station 30-2 is located in the area AR2 adjacent to the area AR1 and the base station 30-4 is located in the other area AR4 adjacent to the area AR1. Therefore, the generation unit 132 may generate the correction information corresponding to the area AR1 by further using the base station data DA22 (DA22-1 and DA22-2) obtained for the base station 30-2 and the base station data DA24 obtained for the base station 30-4. FIG. 9 illustrates the example where the generation unit 132 generates correction information K1 as the correction information corresponding to the area AR1.

Furthermore, for the area AR2 where the base station 30-2 is located, the generation unit 132 may generate the correction information corresponding to the area AR2 on the basis of the satellite data DA11 to DA14 obtained respectively for the satellites SAx and the base station data DA22 (DA22-1 and DA22-2) obtained for the base station 30-2. In the example of FIG. 9, the base station 30-1 is located in the area AR1 adjacent to the area AR2. Therefore, the generation unit 132 may generate the correction information corresponding to the area AR2 by further using the base station data DA21 obtained for the base station 30-1. Furthermore, because the base station 30-4 is located in the area AR4 close to the area AR2, the generation unit 132 may generate the correction information corresponding to the area AR2 by further using the base station data DA24 obtained for the base station 30-4. FIG. 9 illustrates the example where the generation unit 132 generates correction information K2 as the correction information corresponding to the area AR2.

Furthermore, although no base station 30 is located in the area AR3, the base station 30-2 is located in the area AR2 adjacent to the area AR3 and the base station 30-4 is located in the other area AR4 adjacent to the area AR3. Therefore, in a case where the generation unit 132 generates the correction information for the area AR3 where no base station 30 is located, the generation unit 132 may generate the correction information corresponding to the area AR3 on the basis of at least any one of: the satellite data DA11 to DA14 obtained respectively for the satellites SAx; and the base station data DA22 obtained for the base station 30-2 (or the base station data DA24 obtained for the base station 30-4). Furthermore, because the base station 30-1 is located in the area AR1 close to the area AR3, the generation unit 132 may generate the correction information corresponding to the area AR3 by further using the base station data DA21 obtained for the base station 30-1. FIG. 9 illustrates the example where the generation unit 132 generates correction information K3 as the correction information corresponding to the area AR3.

Furthermore, for the area AR4 where the base station 30-4 is located, the generation unit 132 may generate the correction information corresponding to the area AR4 on the basis of the satellite data DA11 to DA14 obtained respectively for the satellites SAx and the base station data DA24 obtained for the base station 30-4. In the example of FIG. 9, the base station 30-1 is located in the area AR1 adjacent to the area AR4. Therefore, by further using the base station data DA21 obtained for the base station 30-1, the generation unit 132 may generate the correction information corresponding to the area AR4. Furthermore, because the base station 30-2 is located in the area AR2 close to the area AR4, the generation unit 132 may generate the correction information corresponding to the area AR4 by further using the base station data DA22 obtained for the base station 30-2. FIG. 9 illustrates the example where the generation unit 132 generates correction information K4 as the correction information corresponding to the area AR4.

Subsequently, the transmission unit 133 transmits the correction information generated by the generation unit 132 to each of the terminal device 10-1 and the terminal device 10-2 (Step S94). For example, the transmission unit 133 may transmit the correction information to each of the terminal device 10-1 and the terminal device 10-2 via the satellites SAx. For example, the transmission unit 133 may distribute the correction information to the satellites SAx so that the correction information generated by the generation unit 132 is broadcasted to each of the terminal device 10-1 and the terminal device 10-2.

More specifically, by gathering together the correction information generated for each of the areas AR1 to AR4, the transmission unit 133 may generate a list of the correction information and transmit the generated list of the correction information to the satellites SAx so that the generated list of the correction information is broadcasted to each of the terminal device 10-1 and the terminal device 10-2. FIG. 9 illustrates the example where the transmission unit 133 generates a correction information list L2 as the list of the correction information and transmits the generated correction information list L2 to each of the terminal device 10-1 and the terminal device 10-2 via the satellites SAx.

The process of generating the list of correction information may be performed by, for example, the generation unit 132, instead of the transmission unit 133.

Subsequently, in response to obtainment of the correction information list L2 by the obtainment unit 13c, the selection unit 13d of each of the terminal device 10-1 and terminal device 10-2 selects, from the list of correction information, correction information generated for an area corresponding to a position indicated by rough position information on its own terminal device, the area being one of the areas according to the embodiment (Step S95). In the example of FIG. 9, the selection unit 13d of the terminal device 10-1 may determine that the position indicated by the rough position information on the terminal device 10-1 is included in the area AR1 and select the correction information corresponding to the area AR1 from the four sets of correction information included in the correction information list L2. Furthermore, in the example of FIG. 9, the selection unit 13d of the terminal device 10-2 may also determine that the position indicated by the rough position information on the terminal device 10-2 is included in the area AR1 and select the correction information corresponding to the area AR1 from the four sets of correction information included in the correction information list L2.

The correction unit 13e then executes calculation for correcting its position information on the basis of the correction information selected by the selection unit 13d (Step S96). For example, by correcting its rough position information through PPP-RTK calculation using the correction information, the correction unit 13e may calculate corrected position information. This position information calculated is position information that is more accurate than the rough position information.

Subsequently, the transmission unit 13f of each of the terminal device 10-1 and terminal device 10-2 transmits the corrected position information calculated by the correction unit 13e, to the determination apparatus 200 (Step S97). In this case, the corrected position information obtainment unit 231 of the determination apparatus 200 obtains the corrected position information from each of the terminal device 10-1 and terminal device 10-2.

FIG. 9 also illustrates the example where the same step number has been assigned to the process performed by the terminal device 10-1 and the process performed by the terminal device 10-2 and both of these processes are performed at the same time. However, because the terminal device 10-1 and the terminal device 10-2 may be activated at different times, their processes illustrated in FIG. 9 may be performed individually depending on these times.

The process described thus far enables the determination apparatus 200 to know accurate position information on each of the terminal device 10-1 and terminal device 10-2, the accurate position information having been obtained by the PPP-RTK method. In a case where the determination apparatus 200 has already obtained the accurate position information on each of the terminal device 10-1 and terminal device 10-2 as described above, the user U1 is able to input definition information to the determination apparatus 200, the definition information defining a mode of movement, the mode indicating a route through which the mobile object 60 is caused to move.

In the example of FIG. 9, in a state where the terminal devices 10-1 and 10-2 are to be used, the user U1 inputs definition information to the determination apparatus 200, the definition information defining a movement route with these terminal devices being the points of origin. In the example of FIG. 9, for example, the user U1 is able to define a target point with reference to the terminal device 10-2. For example, the user U1 inputs definition information to the determination apparatus 200, the definition information defining target points (targets points joining between a start target and an arrival target) on a movement route using directions and distances, like “‘a point (current location point of the mobile object 60) where the terminal device 10-2 is currently positioned’ (start target point M91), ‘a point 20 km east (corresponding to N91)’ of the target point M91 (relay target point M92), and ‘a point where the terminal device 10-1 is currently positioned’ from the target point M92 (arrival target point M93)”. Furthermore, in this case, the reception unit 232 of the determination apparatus 200 receives this definition information (Step S98).

In response to reception of the definition information by the reception unit 232, the determination unit 233 of the determination apparatus 200 executes a route determination process for determining a movement route for the mobile object 60 on the basis of this definition information and the corrected position information on the terminal device 10-1 or terminal device 10-2 (Step S99). For example, the determination unit 233 may determine a movement route for the mobile object 60, the movement route being a route including a relative position with reference to the position indicated by the corrected position information, the relative position satisfying the definition information.

For example, the determination unit 233 may calculate a position of the target point M92 that is a relative position with reference to a position (reference coordinates m91) indicated by the corrected position information corresponding to the terminal device 10-2, the relative position satisfying “‘a point 10 km east’ of the terminal device 10-2”. For example, by calculating the relative coordinates m92 on the basis of the reference coordinates m91 and ‘20 km’ east, the determination unit 233 may determine the relative coordinates m92 as the position of the target point M92.

Furthermore, the determination unit 233 may determine, as a movement route, a path K9 that is a combination of a straight line path having a vector directed from the target point M91 to the target point M92 and a straight line path having a vector directed from the target point M92 to the target point M93, the path K9 being straight-lined. By inputting route information indicating the path K9 to the mobile object 60, the instruction unit 234 may instruct the mobile object 60 to move in a straight line via the target point 92 from the target point M91 (start target) to the target point M93 (arrival target).

In another example, the user U1 may define a target point with reference to the terminal device 10-1. For example, the user U1 may input definition information to the determination apparatus 200, the definition information defining target points on a movement route using directions and distances, like “‘a point where the terminal device 10-1 is currently positioned’ (arrival target point M93), ‘a point 10 km south (corresponding to N93)’ of the target point M93 (relay target point M92), and ‘a point (current location point of the mobile object 60) where the terminal device 10-2 is currently positioned’ from the target point M92 (start target point M91)”.

In this case, the determination unit 233 may calculate a position of the target point M92 that is a relative position with reference to a position (reference coordinates m93) indicated by the corrected position information corresponding to the terminal device 10-1, the relative position satisfying “‘a point 10 km south’ of the terminal device 10-1”. For example, by calculating the relative coordinates m92 on the basis of the reference coordinates m93 and ‘10 km’ south, the determination unit 233 may determine the relative coordinates m92 as the position of the target point M92.

Furthermore, the determination unit 233 may determine, as a movement route, a path K8 that is a combination of a straight line path having a vector directed from the target point M91 to the target point M92 and a straight line path having a vector directed from the target point M92 to the target point M93, the path K8 being straight-lined. By inputting route information indicating the path K9 to the mobile object 60, the instruction unit 234 may instruct the mobile object 60 to move in a straight line via the target point 92 from the target point M91 (start target) to the target point M93 (arrival target).

### Second Embodiment

### 1. Re Route Determination Process

Specific examples of the second embodiment will be described hereinafter by use of FIG. 10 to FIG. 19. As described above, with respect to the second embodiment, a scene where the route determination process according to the embodiment is applied will be described with a focus on a route determination process for drones. In the field of drones, either the PPP method or the PPP-RTK method may be adopted, but the PPP-RTK method, which enables accurate and steady position determination in a narrow range can be said to be suitable for major uses (for example, inspection, surveying, agriculture, and architecture).

Accordingly, the examples of FIG. 10 to FIG. 19 will be described on the assumption that corrected position information obtained by PPP-RTK position determination is used. Specifically, explanation will be made on the assumption that the determination apparatus 200 has obtained corrected position information on a terminal device 10-x, the corrected position information having been obtained by PPP-RTK position determination through the process described thus far. Furthermore, the examples illustrated in FIG. 10 to FIG. 19 are examples of the route determination process for respective variations of the way a terminal device 10-x is used (the installation method and installation mode) and the way definition is made correspondingly to the way of use.

Furthermore, FIG. 10 to FIG. 19 are explanatory diagrams for explanation of examples for drones, and a ‘mobile object 60’ is thus reworded as an ‘air vehicle 60’, and a ‘movement route’ as a ‘flight route’.

The variations of the method of installation and definition information described with respect to the examples hereinafter are just examples and a user may perform installation and input in various ways depending on the purpose. Furthermore, a route determination process according to the second embodiment is not limited to the following examples. In FIG. 10 to FIG. 19, values indicating directions, distances, and heights are represented by use of reference signs ‘N71’ to ‘N141’ but any values may be applied according to the situation and use. That is, depending on the definition information, any values may be applied to the route determination process according to the embodiment. Furthermore, in the following description, specific directions, distances, and heights will be referred to with respect to the directions, distances, and heights indicated by the reference signs, ‘N71’ to ‘N141’, like, for example, ‘10 m in the air right above’ for convenience, but definition information defined by a user is not limited to these examples. That is, a user may define target points by using any directions, distances, and heights.

### 1-1. Route Determination Process (1)

FIG. 10 is a first diagram illustrating an example of the route determination process according to the second embodiment. FIG. 10 illustrates an example of a case where a single terminal device 10-1 is installed at a target position and is to be used. That is, a user U1 may input definition information to the determination apparatus 200, the definition information defining a flight route with the terminal device 10-1 being the point of origin, the flight route being straight-lined, in a state where the single terminal device 10-1 is to be used by installation of the terminal device 10-1 at the target position.

The user U1 may, for example, input definition information to the determination apparatus 200, the definition information defining target points on a flight route using directions, distances, and heights, with the terminal device 10-1 being a starting point. Specifically, the user U1 may input definition information to the determination apparatus 200, the definition information defining target points on a flight route using directions, distances, and heights, like, for example, “‘a point 10 m (corresponding to N71) in the air right above’ the terminal device 10-1 (target point M11), ‘a point 3 m east (corresponding to N72)’ of the target point M11 (target point M12), and ‘a point 5 m north (corresponding to N73)’ of the target point M12 (target point M13)”. The reception unit 232 of the determination apparatus 200 may receive this definition information.

The user U1 may, for example, input such definition information in a case where the user U1 has an aim of wanting to capture an image of a specific area from up in the air through a specific path, or wanting to spray an agricultural chemical from the air above to a specific area through a specific path.

In the example of FIG. 10, the determination unit 233, may, for example, calculate, as the position of the target point M11, a relative position with reference to a position (reference coordinates P10-1) indicated by corrected position information corresponding to the terminal device 10-1, the relative position satisfying “‘a point 10 m in the air right above’ the terminal device 10-1”. For example, the determination unit 233 may determine the relative coordinates m11 as the target point M11 by calculating the relative coordinates m11 on the basis of the reference coordinates P10-1, ‘x1, y1, and z1’ and the height, ‘10 m’.

Furthermore, the determination unit 233 may, for example, calculate, as the position of the target point M12, a relative position with reference to the position (reference coordinates P10-1) indicated by the corrected position information corresponding to the terminal device 10-1, the relative position satisfying “‘a point 10 m in the air right above’ the terminal device 10-1, and ‘a point 3 m east’ thereof”. For example, by calculating the relative coordinates m12 on the basis of the reference coordinates P10-1, ‘x1, y1, and z1’, the height, ‘10 m’, and ‘3 m east’, the determination unit 233 may determine the relative coordinates m11 as the position of the target point M12.

Furthermore, the determination unit 233 may, for example, calculate, as the position of the target point M13, a relative position with reference to the position (reference coordinates P10-1) indicated by the corrected position information corresponding to the terminal device 10-1, the relative position satisfying “‘a point 10 m in the air right above’ the terminal device 10-1, ‘a point 3 m east’ thereof, and ‘a point 5 m north’ thereof”. For example, by calculating the relative coordinates m13 on the basis of the reference coordinates P10-1, ‘x1, y1, and z1’, the height, ‘10 m’, ‘3 m east’, and ‘5 m north’, the determination unit 233 may determine the relative coordinates m13 as the position of the target point M13.

Furthermore, the determination unit 233 may, for example, determine, as a flight route, a path K1 that is a combination of a straight line path having a vector directed from the target point M11 to the target point M12 and a straight line path having a vector directed from the target point M12 to the target point M13, the path K1 being straight-lined. By inputting route information indicating the path K1 to an air vehicle 60, the instruction unit 234 may instruct the air vehicle 60 to fly in a straight line via the target point M12 from the target point M11 (start target) to the target point M13 (arrival target).

The user U1 may define the position (reference coordinates P10-1) where the terminal device 10-1 has been installed as a start target and the target point M12 as an arrival target and thereby set a flight route to achieve flight from the position where the terminal device 10-1 has been installed to the target point M12 in a straight line at an angle. Furthermore, the user U1 may define a direction, a distance, and an angle relative to the position (reference coordinates P10-1) where the terminal device 10-1 has been installed and thereby set a flight route to achieve flight from the position where the terminal device 10-1 has been installed to, for example, the target point M12 in a straight line at an angle.

Furthermore, the user U1 may set a circular flight route by defining a center point and a radius. In the example of FIG. 10, the user U1 may set a circular flight route by defining the target point M11 as the center of a circle and defining a radius that is a distance between the target point M11 and the target point M12. Furthermore, the user U1 may, for example, define the target point M13 as a start target and define a direction and a height relative to the target point M13 and thereby set a flight route that achieves: flight to the target point M13 first; and then movement in a straight line in a state where the specific direction and height are maintained from the target point M13.

The user U1 may cause the air vehicle 60 to take off from the point at which the terminal device 10-x has been installed. That is, the air vehicle 60 may, for example, take off from the position where the terminal device 10-1 has been installed and fly to the target point M11. The air vehicle 60 may then fly from the target point M11 to arrive at the target point M13.

Furthermore, the user U1 may cause the air vehicle 60 to take off from a position separate, by a predetermined distance, from the position where the terminal device 10-x has been installed. In this case, the reception unit 232 may receive definition information defining the point of takeoff, for example. For example, the reception unit 232 may receive definition information defining, using an element having the terminal device 10-1 as the point of origin, like ‘the point of takeoff is at a position separate from the terminal device 10-1 by 100 m’. That is, the air vehicle 60 may take off from the point of takeoff and fly to the target point M11. The air vehicle 60 may then fly from the target point M11 to arrive at the target point M13. After arriving at the target point M13, the air vehicle 60 may return to and land on the ground at the point of takeoff.

The air vehicle 60 may land at any point after arriving at the target point M13. The air vehicle 60 may, for example, land at the point where the air vehicle 60 took off. The air vehicle 60 may, for example, land at the position where the terminal device 10-1 has been installed. The air vehicle 60 may, for example, land at a dedicated station where the air vehicle 60 is to be stored. The air vehicle 60 may, for example, land at any point specified by a user.

The determination unit 233 may determine a point of takeoff at which the air vehicle 60 is caused to take off onto a flight route, on the basis of corrected position information corresponding to a terminal device 10-x to be used.

For example, the determination unit 233 may calculate, as the position of the point of takeoff, a relative position with reference to a position indicated by the corrected position information corresponding to the terminal device 10-x, the relative position satisfying definition information defining the point of takeoff. Furthermore, the instruction unit 234 may instruct takeoff onto the flight route from the calculated position. In this case, the air vehicle 60 may, for example, fly toward the point of takeoff first from the current position and land at the point of takeoff. Thereafter, the air vehicle 60 may take off to head to a target point (for example, a start target) included in the flight route.

### 1-2. Route Determination Process (2)

FIG. 11 is a second diagram illustrating an example of the route determination process according to the second embodiment. FIG. 11 illustrates an example of a case where a user U1 installs a terminal device 10-1 at one end of a building BD, the one end being on the ground, according to an aim of wanting to inspect a wall surface corresponding to a predetermined floor of the building BD, the one end corresponding to that wall surface, and installs a terminal device 10-2 at another end of the building BD, this other end being on the ground. For example, the user U1 may install the terminal device 10-1 at a point separate by 3 m (corresponding to N81) from the one end of the building BD, the one end being on the ground, and install the terminal device 10-2 at a point separate by 3 m (corresponding to N82) from that other end of the building BD, the other end being on the ground. That is, the user U1 may, for example, input definition information to the determination apparatus 200, the definition information defining a flight route with the terminal devices 10-1 and 10-2 being the points of origin, the flight route being straight lined, in a state where the terminal devices 10-1 and 10-2 are to be used.

Specifically, the user U1 may, for example, input definition information to the determination apparatus 200, the definition information defining target points on a flight route using directions and heights, like “achieving flight from ‘a point 10 m (corresponding to N83) in the air’ over the terminal device 10-1 (target point M21) to ‘a point 10 m (corresponding to N84) in the air’ over the terminal device 10-2 (target point M23)”. In this case, the reception unit 232 of the determination apparatus 200 may receive this definition information.

In this case, the determination unit 233 may calculate, as the positions of the target points, relative positions with reference to corrected position information (reference coordinates) corresponding respectively to the two terminal devices 10-x, the relative positions satisfying the definition information. Specifically, for example, the determination unit 233 may calculate relative coordinates m21 on the basis of reference coordinates P10-1, ‘x3, y3, and z3’, corresponding to the terminal device 10-1 and a height, ‘10 m’. The determination unit 233 may then determine the calculated relative coordinates m21 as the position of the target point M21. Furthermore, for example, the determination unit 233 may calculate relative coordinates m22 on the basis of reference coordinates P10-2, ‘x4, y4, and z4’, corresponding to the terminal device 10-2 and the height, ‘10 m’. The determination unit 233 may then determine the calculated relative coordinates m22 as the position of a target point M22.

Furthermore, the determination unit 233 may determine a flight route that is a path K2 having a vector directed from the target point M21 to the target point M22, the path K2 being a straight-lined path. By inputting route information indicating the path K2 to an air vehicle 60, the instruction unit 234 may instruct the air vehicle 60 to fly in a straight line from the target point M21 (start target) to the target point M22 (arrival target).

### 1-3. Route Determination Process (3)

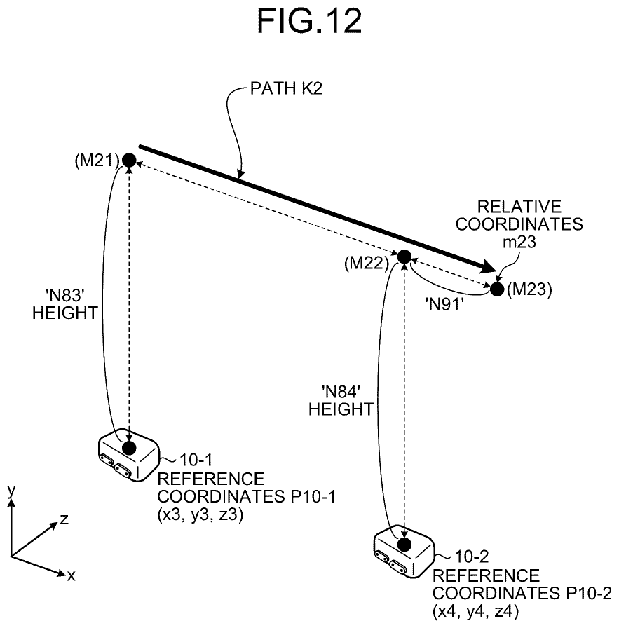

FIG. 11 illustrates the example where the definition information is input so that the line segment joining the respective points in the air over the two terminal devices 10-x is set as the flight route. However, the user U1 may input definition information so that a flight route is set, the flight route extending the line segment joining the respective points in the air over the two terminal devices 10-x further by a predetermined distance. FIG. 12 illustrates, as a modified example corresponding to FIG. 11, an example of such definition information and an example of a route determination process based on the definition information. FIG. 12 is a third diagram illustrating an example of the route determination process according to the second embodiment.

The user U1 may, for example, input definition information to the determination apparatus 200, the definition information being definition information for setting a flight route extended further by a predetermined distance, like, “further extension to ‘a point 5 m (corresponding to N91)’ (target point M23) from ‘a point 10 m in the air’ over the terminal device 10-2 (target point M22)”. In this case, the reception unit 232 of the determination apparatus 200 may receive this definition information.

In this case, the determination unit 233 may calculate position information on the basis of a vector (direction) toward the target point M22 from the target point M21 and reference coordinates P10-2, ‘x4, y4, and z4’. The determination unit 233 may, for example, calculate relative coordinates m23 on the basis of the position information indicating the position of the target point M21 and the extended distance, ‘5 m’. The determination unit 233 may then determine the relative coordinates m23 as the position of the target point M23.

Furthermore, the determination unit 233 may determine a flight route that is a path K21 having a vector directed from the target point M21 to the target point M23 and being straight-lined. The instruction unit 234 may then input the route information indicating the path K21 to an air vehicle 60. That is, the instruction unit 234 may instruct the air vehicle 60 to fly in a straight line via the target point M22 from the target point M21 (start target) to the target point M23 (arrival target).

### 1-4. Route Determination Process (4)

FIG. 13 is a fourth diagram illustrating an example of the route determination process according to the second embodiment. FIG. 13 illustrates an example of a case where a user U1 has installed a terminal device 10-1 at one end of a building BD, the one end being on the ground, according to an aim of wanting to thoroughly inspect a wall surface corresponding to a second floor to a fifth floor of the building BD, the one end corresponding to the wall surface, and has installed a terminal device 10-2 at another end of the building BD, that other end being on the ground. For example, the user U1 may install the terminal device 10-1 at a point 3 m (corresponding to N101) separate from the one end of the building BD, the one end being on the ground, and install the terminal device 10-2 at a point 3 m (corresponding to N102) separate from that other end of the building BD, the other end being on the ground. That is, the user U1 may, for example, input definition information to the determination apparatus 200, the definition information defining vertex points at vertices of a planar area, with the terminal devices 10-1 and 1-2 being the points of origin, in a state where the terminal devices 10-1 and 10-2 are to be used.

Specifically, the user U1 may, for example, input first definition information, “having one vertex (vertex point T11) at ‘a point 5 m (corresponding to N103) in the air’ over the position of the terminal device 10-1 and having another vertex (vertex point T12) at ‘a point 15 m (corresponding to N104) in the air’ over the terminal device 10-1”, to the determination apparatus 200. Furthermore, the user U1 may, for example, input second definition information, “having one vertex (vertex point T21) at ‘a point 5 m (corresponding to N105) in the air’ over the position of the terminal device 10-2 and having another vertex (vertex point T21) ‘at a point 15 m (corresponding to N106) in the air’ over the terminal device 10-2”, to the determination apparatus 200. Furthermore, the user U1 may input third definition information, “a planar area is formed by joining the four vertex points defined by the first definition information and the second definition information”, to the determination apparatus 200. The reception unit 232 of the determination apparatus 200 may receive these sets of definition information.

In this case, the determination unit 233 may calculate, as the positions of the vertex points, relative positions with reference to corrected position information (reference coordinates) corresponding respectively to the two terminal devices 10-x, the relative positions satisfying the first definition information to the third definition information.

Specifically, the determination unit 233 may calculate relative coordinates t11 on the basis of reference coordinates P10-1, ‘x3, y3, and z3’, corresponding to the terminal device 10-1 and the height, ‘5 m’. The determination unit 233 may then determine the relative coordinates t11 as the position of the vertex point T11. Furthermore, the determination unit 233 may, for example, calculate relative coordinates t12 on the basis of the reference coordinates P10-1, ‘x3, y3, and z3’, corresponding to the terminal device 10-1 and the height, ‘15 m’. The determination unit 233 may then determine the relative coordinates t12 as the position of the vertex point T12. Furthermore, the determination unit 233 may, for example, calculate relative coordinates t21 on the basis of reference coordinates P10-2, ‘x4, y4, and z4’, corresponding to the terminal device 10-2 and the height, ‘5 m’. The determination unit 233 may then determine the relative coordinates t21 as the position of the vertex point T21. Furthermore, the determination unit 233 may, for example, calculate relative coordinates t22 on the basis of the reference coordinates P10-2, ‘x4, y4, and 24’, corresponding to the terminal device 10-2 and the height, ‘15 m’. The determination unit 233 may then determine the relative coordinates t22 as the position of the vertex point T22.

Furthermore, the determination unit 233 may generate a planar area AR11 by joining the determined four vertex points T11, T12, T21, and T22. For example, the determination unit 233 may determine, as a flight route, a path of movement in the planar area AR11 along the planar area AR11. Furthermore, the instruction unit 234 may instruct an air vehicle 60 to move thoroughly in the planar area AR11, by inputting the route information indicating the determined flight route to the air vehicle 60. In a case where the air vehicle 60 flies while capturing an image of the flight route, the determination unit 233 may determine the flight route by using a lap ratio of the captured image. For example, the determination unit 233 may calculate the lap ratio with respect to the traveling direction and the lap ratio with respect to the adjacency, and determine a flight route so that the image captured will have the lap ratios calculated.

### 1-5. Route Determination Process (5)

FIG. 14 is a fifth diagram illustrating an example of the route determination process according to the second embodiment. FIG. 14 illustrates an example of a case where a user U1 has installed a terminal device 10-1 at one end of a building BD, the one end being on the ground, and has installed a terminal device 10-2 at another end of the building BD, this other end being on the ground, according to an aim of wanting to make an air vehicle 60 fly in a predetermined mode with respect to a three-dimensional area surrounding the building BD. For example, the user U1 may install the terminal device 10-1 at a point 3 m separate from the one end of the building BD, the one end being on the ground, and install the terminal device 10-2 at a point 3 m separate from that other end of the building BD, the other end being on the ground. That is, the user U1 may, for example, input definition information to the determination apparatus 200, the definition information defining vertex points at vertices of the three-dimensional area, with the terminal devices 10-1 and 10-2 being the points of origin, in a state where the terminal devices 10-1 and 10-2 are to be used.

Specifically, the user U1 may, for example, input first definition information, “having one vertex (vertex point T31) at the position of the terminal device 10-1 and another vertex (vertex point T34) at ‘a point at a depth of 10 m (corresponding to N111)’ from the terminal device 10-1”, to the determination apparatus 200. Furthermore, the user U1 may, for example, input second definition information, “having one vertex (vertex point T32) at the position of the terminal device 10-2 and another vertex (vertex point T33) at ‘a point at a depth of 10 m (corresponding to N112)’ from the terminal device 10-2”, to the determination apparatus 200. Furthermore, the user U1 may, for example, input third definition information, “a three-dimensional area having: as a bottom surface, a surface bounded by the vertex points T31 to T34 joined to each other; and a height, ‘30 m’ (corresponding to N113)”, to the determination apparatus 200. The reception unit 232 of the determination apparatus 200 may receive these sets of definition information.

In this case, the determination unit 233 may calculate, as the positions of the vertex points, positions with reference to corrected position information (reference coordinates) corresponding respectively to the two terminal devices 10-x, the positions satisfying the first definition information to the third definition information.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, calculate relative coordinates t34 on the basis of the reference coordinates P10-1, ‘x3, y3, and z3’, corresponding to the terminal device 10-1 and the depth, ‘10 m’. The determination unit 233 may then determine the relative coordinates t34 as the position of the vertex point T34. Furthermore, the determination unit 233 may, for example, determine, as the position of the vertex point T32, the reference coordinates P10-2, ‘x4, y4, and z4’, corresponding to the terminal device 10-2. Furthermore, the determination unit 233 may, for example, calculate relative coordinates t33 on the basis of the reference coordinates P10-2, ‘x4, y4, and z4’, corresponding to the terminal device 10-2 and the depth, ‘10 m’, and thereby determine the relative coordinates t33 as the position of the vertex point T33.

Furthermore, the determination unit 233 may calculate, as the positions of the vertex points, relative positions with reference to corrected position information (reference coordinates) corresponding respectively to the two terminal devices 10-x, the relative positions satisfying the third definition information. For example, the determination unit 233 may calculate the remaining four vertex points (vertex points T35 to T38) corresponding to the height, ‘30 m’, in a case where the surface bounded by the vertex points T31 to T34 joined to each other is the bottom surface.

For example, the determination unit 233 may calculate relative coordinates t35 and t38 on the basis of the reference coordinates P10-1, ‘x3, y3, and z3’, corresponding to the terminal device 10-1, the depth, ‘10 m’, and the height, ‘30 m’. Furthermore, the determination unit 233 may determine the relative coordinates t35 as the position of the vertex point T35 and the relative coordinates t38 as the position of the vertex point T38. Furthermore, for example, the determination unit 233 may calculate relative coordinates t36 and t37 on the basis of the reference coordinates P10-2, ‘x4, y4, and z4’, corresponding to the terminal device 10-2, the depth, ‘10 m’, and the height, ‘30 m’. The determination unit 233 may then, for example, determine the relative coordinates t36 as the position of the vertex point T36 and the relative coordinates t37 as the position of the vertex point T37.

Furthermore, the determination unit 233 may generate a three-dimensional area AR12 by joining the determined eight vertex points T31 to T38.

Furthermore, on the basis of the three-dimensional area AR12, the determination unit 233 may determine a flight route. The determination unit 233 may, for example, determine a flight route that is a path through which an air vehicle moves in a predetermined planar area (for example, a planar area bounded by the vertex points T31, T32, T35, and T36 joined to each other) of planar areas forming the three-dimensional area AR12, to be along the predetermined planar area. Furthermore, for example, the determination unit 233 may determine a flight route that is a path through which an air vehicle 60 moves outside the three-dimensional area AR12 so that the air vehicle 60 does not enter the three-dimensional area AR12. Furthermore, for example, the determination unit 233 may determine a flight route that is path through which an air vehicle moves in the three-dimensional area AR12 without exiting the three-dimensional area AR12.

In the example of FIG. 14, on the basis of definition information from the user U1, the determination unit 233 generates a three-dimensional area that is what is called a rectangular parallelepiped, in a space. However, the user U1 may define a three-dimensional area having any shape by means of definition information, depending on the purpose. That is, the user U1 may, for example, cause the determination unit 233 to generate any of three-dimensional areas having various shapes according to: how many terminal devices 10-x are to be installed in what positional relations; and what heights are defined. That is, on the basis of definition information, the determination unit 233 may generate a three-dimensional area having any shape.

For example, in the example of FIG. 14, depending on the height, the determination unit 233 is able to generate a cubical three-dimensional area in a space. Furthermore, for example, the determination unit 233 is able to generate a three-dimensional area that is a triangular prism in a space, in a case where a total of six vertex points have been defined by use of: three vertex points, vertex points T31, T32, and T33 (or a vertex point T34); and a height.

### 1-6. Route Determination Process (6)

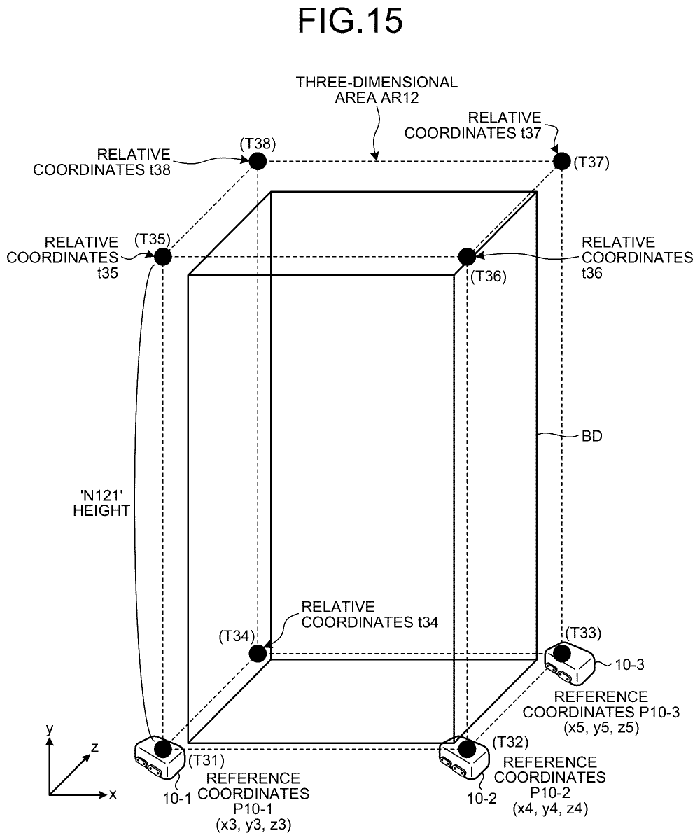

FIG. 15 is a sixth diagram illustrating an example of the route determination process according to the second embodiment. FIG. 15 illustrates an example of a case where a user U1 has installed a terminal device 10-1, a terminal device 10-2, and a terminal device 10-3 respectively at three ends of a building BD, the three ends being on the ground, according to an aim of wanting to make an air vehicle 60 fly in a predetermined mode with respect to a three-dimensional area surrounding the building BD. The example in FIG. 15 is different from the example in FIG. 14 in that the terminal device 10-3 has been additionally installed on the ground at another end of the building BD. That is, the user U1 may, for example, input definition information to the determination apparatus 200, the definition information defining vertex points at vertices of the three-dimensional area, with these terminal devices 10-1 to 10-3 being the points of origin, in a state where the terminal devices 10-1 to 10-3 are to be used.

Specifically, the user U1 may input first definition information, “one vertex (vertex point T31) is at the position of the terminal device 10-1”, to the determination apparatus 200. Furthermore, the user U1 may, for example, input second definition information, “one vertex (vertex point T32) is at the position of the terminal device 10-2”, to the determination apparatus 200. Furthermore, the user U1 may, for example, input third definition information, “one vertex (vertex point T33) is at the position of the terminal device 10-3”, to the determination apparatus 200. Furthermore, the user U1 may, for example, input fourth definition information, “another vertex (vertex point T34) is at a position on a diagonal based on first definition information to third definition information”, to the determination apparatus 200. Furthermore, the user U1 may, for example, input fifth definition information, “a three-dimensional area having: as a bottom surface, a surface bounded by the vertex points T31 to T34 joined to each other; and a height, ‘30 m’ (corresponding to N121)”, to the determination apparatus 200.

In this case, the determination unit 233 may calculate, as the positions of the vertex points, positions satisfying the first definition information to the fifth definition information, with reference to corrected position information (reference coordinates) corresponding respectively to the three terminal devices 10-x on the ground.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, determine, as the position of the vertex point T32, reference coordinates P10-2, ‘x4, y4, and z4’, corresponding to the terminal device 10-2. Furthermore, the determination unit 233 may, for example, determine, as the position of the vertex point T33, reference coordinates P10-3, ‘x5, y5, and z5’, corresponding to the terminal device 10-3. Furthermore, the determination unit 233 may, for example, determine relative coordinates t34 as the position of the vertex point T34 by calculating the relative coordinates t34 on the basis of these three sets of reference coordinates.

Furthermore, the determination unit 233 may calculate, as the positions of the vertex points, relative positions with reference to corrected position information (reference coordinates) corresponding respectively to the three terminal devices 10-x on the ground, the relative positions satisfying the fifth definition information. For example, the determination unit 233 may calculate the remaining four vertex points (vertex points T35 to T38) corresponding to a height, ‘30 m’, in a case where the surface bounded by the vertex points T31 to T34 joined to each other is the bottom surface.

For example, the determination unit 233 may calculate relative coordinates t35 on the basis of the reference coordinates P10-1, ‘x3, y3, and z3’, corresponding to the terminal device 10-1 and the height, ‘30 m’, and thereby determine the relative coordinates t35 as the position of the vertex point T35. Furthermore, for example, the determination unit 233 may calculate relative coordinates t36 on the basis of the reference coordinates P10-2, ‘x4, y4, and z4’, corresponding to the terminal device 10-2 and the height, ‘30 m’. The determination unit 233 may then determine the relative coordinates t36 as the position of the vertex point T36. Furthermore, for example, the determination unit 233 may calculate relative coordinates t37 on the basis of the reference coordinates P10-1, ‘x5, y5, and z5’, corresponding to the terminal device 10-3 and the height, ‘30 m’. The determination unit 233 may then determine the relative coordinates t37 as the position of the vertex point T37. Furthermore, for example, the determination unit 233 may calculate the remaining relative coordinates t38 on the basis of relations between the relative coordinates t35 to t37. The determination unit 233 may then determine the relative coordinates t38 as the position of the vertex point T38.

Furthermore, the determination unit 233 may generate a three-dimensional area AR12 by joining the determined eight vertex points T31 to T38. Furthermore, the determination unit 233 may determine a flight route of an air vehicle according to definition information by the user U1. The flight route may be a path similar to the path described with respect to the route determination process (5). Furthermore, the instruction unit 234 may input the route information indicating the determined flight route, to the air vehicle 60.

### 1-7. Route Determination Process (7)

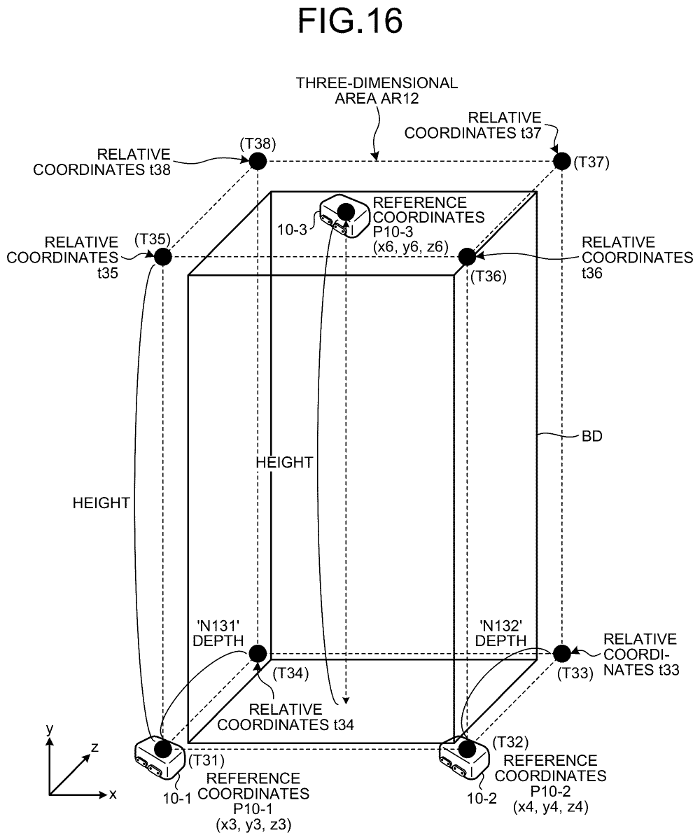

FIG. 16 is a seventh diagram illustrating an example of the route determination process according to the second embodiment. FIG. 16 illustrates an example of a case where a user U1 has installed a terminal device 10-1 and a terminal device 10-2 respectively at two ends of a building BD, the two ends being on the ground, and has installed a terminal device 10-3 on the roof of the building BD, according to an aim of wanting to make an air vehicle 60 fly in a predetermined mode with respect to a three-dimensional area surrounding the building BD. The example in FIG. 16 is different from the example in FIG. 15 in the point where the terminal device 10-3 is installed for the building BD. Specifically, in the example of FIG. 15, the terminal device 10-3 is installed at one end of the building BD, the one end being on the ground, to prescribe one of the vertex points, and in the example of FIG. 16, the terminal device 10-3 is installed on the roof of the building BD to prescribe a height. That is, the user U1 may, for example, input definition information to the determination apparatus 200, the definition information defining vertex points at vertices of the three-dimensional area, with these terminal devices 10-1 to 10-3 being the points of origin, in a state where the terminal devices 10-1 to 10-3 are to be used.

Specifically, the user U1 may, for example, input first definition information, “‘having one vertex (vertex point T31) at the position of the terminal device 10-1 and another vertex (vertex point T34) at ‘a point at a depth of 10 m (corresponding to N131)’ from the terminal device 10-1”, to the determination apparatus 200. Furthermore, the user U1 may, for example, input second definition information, “‘having one vertex (vertex point T32) at the position of the terminal device 10-2 and another vertex (vertex point T33) at ‘a point at a depth of 10 m (corresponding to N132)’ from the terminal device 10-2”, to the determination apparatus 200. Furthermore, the user U1 may, for example, input third definition information, “a three-dimensional area having: as a bottom surface, a surface bounded by the vertex points T31 to T34; and a height at the position of the terminal device 10-3”, to the determination apparatus 200.

In this case, the determination unit 233 may calculate, as the positions of the vertex points, positions satisfying the first definition information to the third definition information, with reference to corrected position information (reference coordinates) corresponding to the two terminal devices 10-x on the ground.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, calculate relative coordinates t34 on the basis of the reference coordinates P10-1, ‘x3, y3, and z3’, corresponding to the terminal device 10-1 and the depth, ‘10 m’. The determination unit 233 may then determine the relative coordinates t34 as the position of the vertex point T34. Furthermore, the determination unit 233 may, for example, determine, as the position of the vertex point T32, reference coordinates P10-2, ‘x4, y4, and z4’, corresponding to the terminal device 10-2. Furthermore, the determination unit 233 may, for example, calculate relative coordinates t33 on the basis of the reference coordinates P10-2, ‘x4, y4, and z4’, corresponding to the terminal device 10-2 and the depth, ‘10 m’. The determination unit 233 may then determine the relative coordinates t33 as the position of the vertex point T33.

Furthermore, the determination unit 233 may calculate, as positions of vertex points, relative positions with reference to coordinates (reference coordinates) of positions indicated by corrected position information corresponding respectively to the terminal devices 10-x, the relative positions satisfying the third definition information. For example, the determination unit 233 may calculate the remaining four vertex points (vertex points T35 to T38) by applying a height indicated by reference coordinates P10-3, ‘x6, y6, and z6’, corresponding to the terminal device 10-3 to the surface bounded by the vertex points T31 to T34 joined to each other.

For example, the determination unit 233 may calculate relative coordinates t35 and t38, on the basis of the reference coordinates P10-1, ‘x3, y3, and z3’, corresponding to the terminal device 10-1, the depth, ‘10 m’, and the reference coordinates P10-3. The determination unit 233 may then determine the relative coordinates t35 as the position of the vertex point T35 and the relative coordinates t38 as the position of the vertex point T38. Furthermore, for example, the determination unit 233 may calculate relative coordinates t36 and t37, on the basis of the reference coordinates P10-2, ‘x4, y4, and z4’, corresponding to the terminal device 10-2, the depth, ‘10 m’, and the reference coordinates P10-3. The determination unit 233 may then determine the relative coordinates t36 as the position of the vertex point T36 and the relative coordinates t37 as the position of the vertex point T37.

Furthermore, the determination unit 233 may generate a three-dimensional area AR12 by joining the determined eight vertex points T31 to T38. Furthermore, the determination unit 233 may determine a flight route according to definition information by the user U1. The flight route may be a path similar to the path described with respect to the route determination process (5). Furthermore, the instruction unit 234 may input the route information indicating the determined flight route, to the air vehicle 60.

### 1-8. Route Determination Process (8)

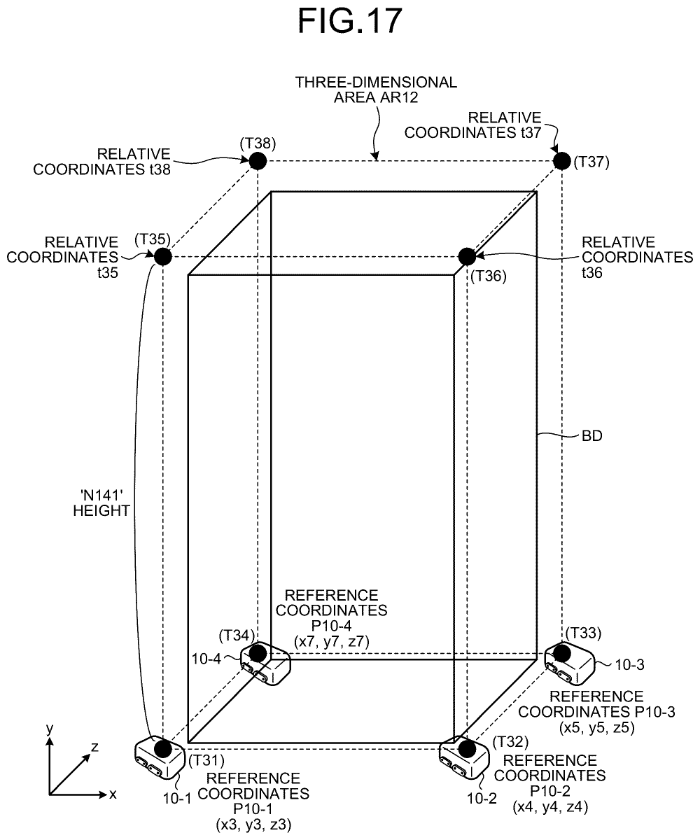

FIG. 17 is an eighth diagram illustrating an example of the route determination process according to the second embodiment. FIG. 17 illustrates an example of a case where a user U1 has installed a terminal device 10-1, a terminal device 10-2, a terminal device 10-3, and a terminal device 10-4 respectively at four ends of a building BD, the four ends being on the ground, according to an aim of wanting to make an air vehicle 60 fly in a predetermined mode with respect to a three-dimensional area surrounding the building BD. In the example of FIG. 17, one terminal device 10-x has been added further (a total of four), as compared to FIG. 15. Furthermore, in the example of FIG. 17, the one terminal device 10-x added has been additionally installed at the remaining one end of the building BD, as compared to FIG. 15. Specifically, in the example of FIG. 17, the terminal device 10-4 added has been installed at the remaining one end of the building BD. That is, the user U1 may, for example, input definition information to the determination apparatus 200, the definition information defining vertex points at vertices of the three-dimensional area, with these terminal devices 10-1 to 10-4 being the points of origin, in a state where the terminal devices 10-1 to 10-4 are to be used.

Specifically, the user U1 may input first definition information, “one vertex (vertex point T31) is at the position of the terminal device 10-1”, to the determination apparatus 200. Furthermore, the user U1 may, for example, input second definition information, “one vertex (vertex point T32) is at the position of the terminal device 10-2”, to the determination apparatus 200. Furthermore, the user U1 may, for example, input third definition information, “one vertex (vertex point T33) is at the position of the terminal device 10-3”, to the determination apparatus 200. Furthermore, the user U1 may, for example, input fourth definition information, “one vertex (vertex point T34) is at the position of the terminal device 10-4”, to the determination apparatus 200. Furthermore, the user U1 may, for example, input fifth definition information, “a three-dimensional area having: as a bottom surface, a surface bounded by the vertex points T31 to T34 joined to each other; and a height, ‘30 m’ (corresponding to N141)”, to the determination apparatus 200.

In this case, the determination unit 233 may calculate, as the positions of the vertex points, positions satisfying the first definition information to the fifth definition information, with reference to corrected position information (reference coordinates) corresponding respectively to the four terminal devices 10-x on the ground.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, determine, as the position of the vertex point T32, reference coordinates P10-2, ‘x4, y4, and z4’, corresponding to the terminal device 10-2. Furthermore, the determination unit 233 may, for example, determine, as the position of the vertex point T33, reference coordinates P10-3, ‘x5, y5, and z5’, corresponding to the terminal device 10-3. Furthermore, the determination unit 233 may, for example, determine, as the position of the vertex point T34, reference coordinates P10-3, ‘x7, y7, and z7’, corresponding to the terminal device 10-4.

Furthermore, the determination unit 233 may calculate, as the positions of the vertex points, relative positions with reference to corrected position information (reference coordinates) corresponding respectively to the four terminal devices 10-x, the relative positions satisfying the fifth definition information. For example, the determination unit 233 may calculate the remaining four vertex points (vertex points T35 to T38) corresponding to a height, ‘30 m’, in a case where the surface bounded by the vertex points T31 to T34 joined to each other is the bottom surface.

For example, the determination unit 233 may calculate relative coordinates t35 on the basis of the reference coordinates P10-1, ‘x3, y3, and z3’, corresponding to the terminal device 10-3 and the height, ‘30 m’. The determination unit 233 may then determine the relative coordinates t35 as the position of the vertex point T35. Furthermore, the determination unit 233 may, for example, calculate relative coordinates t36 on the basis of reference coordinates P10-2, ‘x4, y4, and z4’, corresponding to the terminal device 10-2 and the height, ‘30 m’. The determination unit 233 may then determine the relative coordinates t36 as the position of the vertex point T36. Furthermore, the determination unit 233 may, for example, calculate relative coordinates t37 on the basis of reference coordinates P10-1, ‘x5, y5, and z5’, corresponding to the terminal device 10-3 and the height, ‘30 m’. The determination unit 233 may then determine the relative coordinates t37 as the position of the vertex point T37. Furthermore, the determination unit 233 may, for example, calculate relative coordinates t38 on the basis of reference coordinates P10-4, ‘x7, y7, and z7’, corresponding to the terminal device 10-4 and the height, ‘30 m’. The determination unit 233 may then determine the relative coordinates t38 as the position of the vertex point T38.

Furthermore, the determination unit 233 may generate a three-dimensional area AR12 by joining the determined eight vertex points T31 to T38. Furthermore, the determination unit 233 may determine a flight route according to definition information by the user U1. The flight route may be a path similar to the path described with respect to the route determination process (5). Furthermore, the instruction unit 234 may input the route information indicating the determined flight route, to the air vehicle 60.

### 1-9. Route Determination Process (9)

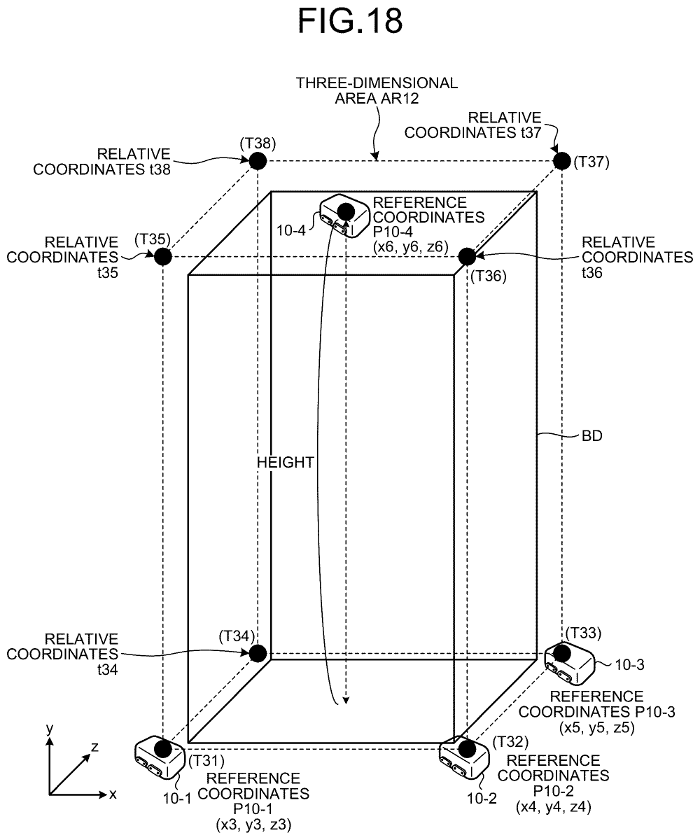

FIG. 18 is a ninth diagram illustrating an example of the route determination process according to the second embodiment. FIG. 18 illustrates an example of a case where a user U1 has installed a terminal device 10-1, a terminal device 10-2, and a terminal device 10-3 respectively at three ends of a building BD, the three ends being on the ground, and has installed a terminal device 10-4 on the roof of the building BD, according to an aim of wanting to make an air vehicle 60 fly in a predetermined mode with respect to a three-dimensional area surrounding the building BD. In the example of FIG. 18, one terminal device 10-x has been added further (a total of four), as compared to FIG. 15. Furthermore, in the example of FIG. 18, the one terminal device 10-x added is further installed on the roof of the building BD, as compared to the example in FIG. 15. Specifically, in the example of FIG. 18, the terminal device 10-4 added has been installed on the roof of the building BD. That is, the user U1 may, for example, input definition information to the determination apparatus 200, the definition information defining vertex points at vertices of the three-dimensional area, with these terminal devices 10-1 to 10-4 being the points of origin, in a state where the terminal devices 10-1 to 10-4 are to be used.

Specifically, the user U1 may, for example, input first definition information, “one vertex (vertex point T31) is at the position of the terminal device 10-1”, to the determination apparatus 200. Furthermore, the user U1 may, for example, input second definition information, “one vertex (vertex point T32) is at the position of the terminal device 10-2”, to the determination apparatus 200. Furthermore, the user U1 may, for example, input third definition information, “one vertex (vertex point T33) is at the position of the terminal device 10-3”, to the determination apparatus 200. Furthermore, the user U1 may, for example, input fourth definition information, “another vertex (vertex point T34) is at a position on a diagonal based on the first definition information to the third definition information”, to the determination apparatus 200. Furthermore, the user U1 may, for example, input fifth definition information, “a three-dimensional area having: as a bottom surface, a surface bounded by the vertex points T31 to T34; and a height at the position of the terminal device 10-4”, to the determination apparatus 200.

In this case, the determination unit 233 may calculate, as the positions of the vertex points, positions satisfying the first definition information to the fifth definition information, with reference to corrected position information (reference coordinates) corresponding respectively to the three terminal devices 10-x on the ground.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, determine, as the position of the vertex point T32, reference coordinates P10-2, ‘x4, y4, and z4’, corresponding to the terminal device 10-2. Furthermore, the determination unit 233 may, for example, determine, as the position of the vertex point T33, reference coordinates P10-3, ‘x5, y5, and z5’, corresponding to the terminal device 10-3. Furthermore, the determination unit 233 may calculate relative coordinates t34 on the basis of these three sets of reference coordinates. The determination unit 233 may, for example, determine the relative coordinates t34 as the position of the vertex point T34.

Furthermore, the determination unit 233 may calculate, as positions of vertex points, relative positions with reference to corrected position information (reference coordinates) corresponding respectively to the terminal devices 10-x, the relative positions satisfying the fifth definition information. For example, the determination unit 233 may calculate the remaining four vertex points (vertex points T35 to T38) by applying a height indicated by reference coordinates P10-4, ‘x6, y6, and z6’, corresponding to the terminal device 10-4, to the surface bounded by the vertex points T31 to T34 joined to each other.

For example, the determination unit 233 may calculate relative coordinates t35 on the basis of the reference coordinates P10-1, ‘x3, y3, and z3’, corresponding to the terminal device 10-1, and the reference coordinates P10-4. The determination unit 233 may then determine the relative coordinates t35 as the position of the vertex point T35. Furthermore, the determination unit 233 may, for example, calculate relative coordinates t36 on the basis of the reference coordinates P10-2, ‘x4, y4, and z4’, corresponding to the terminal device 10-2, and the reference coordinates P10-4. The determination unit 233 may then, for example, determine the relative coordinates t36 as the position of the vertex point T36. Furthermore, the determination unit 233 may, for example, calculate relative coordinates t37 on the basis of the reference coordinates P10-3, ‘x5, y5, and z5’, corresponding to the terminal device 10-3, and the reference coordinates P10-4. The determination unit 233 may then determine the relative coordinates t37 as the position of the vertex point T37. Furthermore, the determination unit 233 may calculate the remaining relative coordinates t38 on the basis of relations between the relative coordinates t35 to t37. The determination unit 233 may then determine the relative coordinates t38 as the position of the vertex point T38.

Furthermore, the determination unit 233 may generate a three-dimensional area AR12 by joining the determined eight vertex points T31 to T38. Furthermore, the determination unit 233 may determine a flight route according to definition information by the user U1. The flight route may be a path similar to the path described with respect to the route determination process (5). Furthermore, the instruction unit 234 may input the route information indicating the determined flight route, to the air vehicle 60.

### 1-10. Route Determination Process (10)

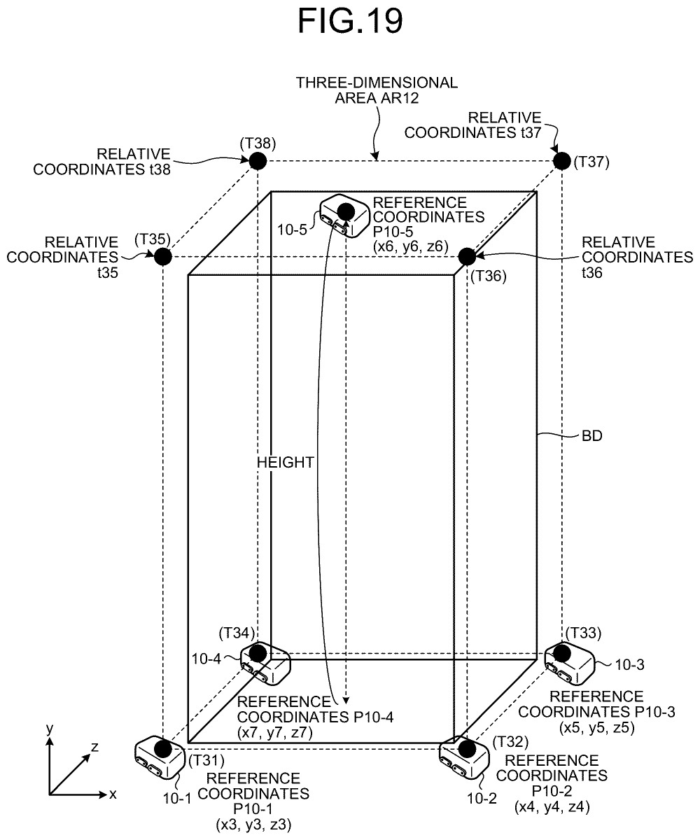

FIG. 19 is a tenth diagram illustrating an example of the route determination process according to the second embodiment. FIG. 19 illustrates an example of a case where a user U1 has installed a terminal device 10-1, a terminal device 10-2, a terminal device 10-3, and a terminal device 10-4 respectively at four ends of a building BD, the four ends being on the ground, and has installed a terminal device 10-5 on the roof of the building BD, according to an aim of wanting to make an air vehicle 60 fly in a predetermined mode with respect to a three-dimensional area surrounding the building BD. In the example of FIG. 19, one terminal device 10-x has been added further (a total of five), as compared to the example in FIG. 17. Furthermore, in the example of FIG. 19, the one terminal device 10-x added is further installed on the roof of the building BD, as compared to the example in FIG. 17. Specifically, in the example of FIG. 19, the terminal device 10-5 added has been installed on the roof of the building BD. That is, the user U1 may, for example, input definition information to the determination apparatus 200, the definition information defining vertex points at vertices of the three-dimensional area, with these terminal devices 10-1 to 10-5 being the points of origin, in a state where the terminal devices 10-1 to 10-5 are to be used.

Specifically, the user U1 may, for example, input first definition information, “one vertex (vertex point T31) is at the position of the terminal device 10-1”, to the determination apparatus 200. Furthermore, the user U1 may, for example, input second definition information, “one vertex (vertex point T32) is at the position of the terminal device 10-2”, to the determination apparatus 200. Furthermore, the user U1 may, for example, input third definition information, “one vertex (vertex point T33) is at the position of the terminal device 10-3”, to the determination apparatus 200. Furthermore, the user U1 may, for example, input fourth definition information, “one vertex (vertex point T34) is at the position of the terminal device 10-4”, to the determination apparatus 200. Furthermore, the user U1 may, for example, input fifth definition information, “a three-dimensional area having: as a bottom surface, a surface bounded by the vertex points T31 to T34 joined to each other; and a height at the position of the terminal device 10-5”, to the determination apparatus 200.

In this case, the determination unit 233 may calculate, as the positions of the vertex points, positions satisfying the first definition information to the fifth definition information, with reference to corrected position information (reference coordinates) corresponding respectively to the four terminal devices 10-x on the ground.

Specifically, the determination unit 233 may, for example, determine, as the position of the vertex point T31, reference coordinates P10-1, ‘x3, y3, and z3’, corresponding to the terminal device 10-1. Furthermore, the determination unit 233 may, for example, determine, as the position of the vertex point T32, reference coordinates P10-2, ‘x4, y4, and z4’, corresponding to the terminal device 10-2. Furthermore, the determination unit 233 may, for example, determine, as the position of the vertex point T33, reference coordinates P10-3, ‘x5, y5, and z5’, corresponding to the terminal device 10-3. Furthermore, the determination unit 233 may, for example, determine, as the position of the vertex point T34, reference coordinates P10-4, ‘x7, y7, and z7’, corresponding to the terminal device 10-4.

Furthermore, the determination unit 233 may calculate, as positions of vertex points, relative positions with reference to coordinates (reference coordinates) of positions indicated by corrected position information corresponding respectively to the terminal devices 10-x, the relative positions satisfying the fifth definition information. For example, the determination unit 233 may calculate the remaining four vertex points (vertex points T35 to T38) by applying a height indicated by reference coordinates P10-5, ‘x6, y6, and z6’, corresponding to the terminal device 10-5, to the surface bounded by the vertex points T31 to T34 joined to each other.

For example, the determination unit 233 may calculate relative coordinates t35 on the basis of the reference coordinates P10-1, ‘x3, y3, and z3’, corresponding to the terminal device 10-1, and the reference coordinates P10-5. The determination unit 233 may then determine the relative coordinates t35 as the position of the vertex point T35. Furthermore, the determination unit 233 may, for example, calculate relative coordinates t36 on the basis of the reference coordinates P10-2, ‘x4, y4, and z4’, corresponding to the terminal device 10-2, and the reference coordinates P10-5. The determination unit 233 may then determine the relative coordinates t36 as the position of the vertex point T36. Furthermore, the determination unit 233 may, for example, calculate relative coordinates t37 on the basis of the reference coordinates P10-3, ‘x5, y5, and z5’, corresponding to the terminal device 10-3, and the reference coordinates P10-5. The determination unit 233 may then determine the relative coordinates t37 as the position of the vertex point T37. Furthermore, the determination unit 233 may, for example, calculate relative coordinates t38 on the basis of the reference coordinates P10-4, 'x7, y7, and z7, corresponding to the terminal device 10-4, and the reference coordinates P10-5. The determination unit 233 may then determine the relative coordinates t38 as the position of the vertex point T38.

Furthermore, the determination unit 233 may generate a three-dimensional area AR12 by joining the determined eight vertex points T31 to T38. Furthermore, the determination unit 233 may determine a flight route according to definition information by the user U1. The flight route may be a path similar to the path described with respect to the route determination process (5). Furthermore, the instruction unit 234 may input the route information indicating the determined flight route, to the air vehicle 60.

### OTHER EMBODIMENTS

Application of terminal devices 10-x to various fields, in addition to the above described examples, is hoped for by combination of the terminal devices 10-x with the route determination processes described with respect to the above described embodiments. Examples of a use case for the terminal devices 10-x will be described hereinafter.

For example, it is assumed that definition information is input according to a purpose, with a terminal device 10-x having been installed for a predetermined object. In this case, in a state of keeping a predetermined distance from the object, the determination apparatus 200 may control an air vehicle 60 so that the air vehicle 60 flies through a flight route following the object. This enables the determination apparatus 200 according to an embodiment to obtain a captured image while keeping a constant distance from the object moving like, for example, a vehicle, a train, or a drone. Furthermore, for example, in a case where an image is captured for the purpose of inspection of the object, the determination apparatus 200 enables increased inspection accuracy by obtaining a captured image with a constant distance maintained in the captured image.

Furthermore, the determination apparatus 200 may determine an optimum flight route on the basis of a history of position information (corrected position information) obtained from a terminal device 10-x. For example, in a case where the terminal device 10-x has been installed in a vehicle, the determination apparatus 200 may detect a movement path indicating a path of movement of the vehicle, on the basis of the history of position information obtained from the terminal device 10-x. In this case, installing the terminal device 10-x in more vehicles enables the determination apparatus 200 to detect statistics on movement paths. That is, the determination apparatus 200 according to an embodiment may detect roads. In this case, the determination apparatus 200 may determine, as a flight route, a path displaced from a movement path, the flight route being in the air over the movement path (roads) detected. Specifically, the determination apparatus 200 may determine a path along the movement path, as the flight route, the path being in the air over the movement path. The determination apparatus 200 according to this embodiment thus enables reduction in risk of an air vehicle 60 falling onto a vehicle or a road. Furthermore, the determination apparatus 200 according to an embodiment may determine a flight route enabling imaging of traffic statuses.

Furthermore, the determination apparatus 200 may determine an optimum flight route for inspection of railroad tracks on the basis of a history of position information (corrected position information) obtained from a terminal device 10-x. In this case, terminal devices 10-x are installed on trains, and the determination apparatus 200 according to this embodiment is able to detect coordinates that are comparatively accurate and corresponding to the railroad tracks. That is, the determination apparatus 200 according to the embodiment enables application of an air vehicle 60 to inspection of a railroad track by determining a flight route that is a path indicated by coordinates corresponding to the railroad track.

### Hardware Configuration

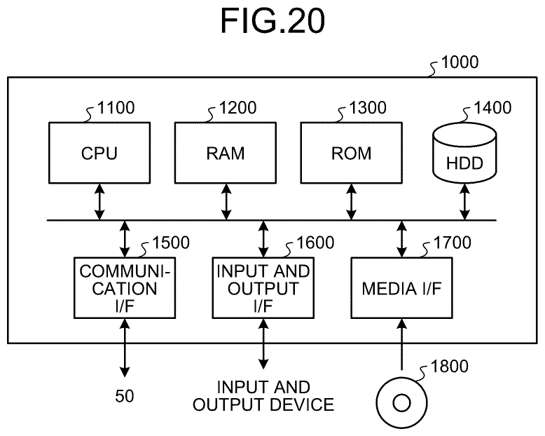

Furthermore, a terminal device 10-x, a mobile device 60, the calculation apparatus 100, and the determination apparatus 200 that are included in the route determination system 1 according to the above described embodiment may, for example, be implemented by a computer 1000 configured as illustrated in FIG. 20. The determination apparatus 200 will be described hereinafter, as an example. FIG. 20 is a hardware configuration diagram illustrating an example of the computer 1000 implementing functions of the determination apparatus 200. The computer 1000 may have a CPU 1100, a RAM 1200, a ROM 1300, an HDD 1400, a communication interface (I/F) 1500, an input and output interface (I/F) 1600, and a media interface (I/F) 1700.

The CPU 1100 may operate on the basis of a program stored in the ROM 1300 or HDD 1400 and control each unit. The ROM 1300 may store a boot program executed by the CPU 1100 upon start-up of the computer 1000 and store a program dependent on hardware of the computer 1000, for example.

The HDD 1400 may store a program executed by the CPU 1100 and data used by the program, for example. The communication interface 1500 may receive data from another device via a communication network 50 and transmit the data to the CPU 1100. The communication interface 1500 may transmit data generated by the CPU 1100 to another device via the communication network 50.

The CPU 1100 may control an output device, such as a display or a printer, and an input device, such as a keyboard or a mouse, via the input and output interface 1600. The CPU 1100 may obtain data from the input device via the input and output interface 1600. Furthermore, the CPU 1100 may output data generated by the CPU 1100 to the output device via the input and output interface 1600.

The media interface 1700 may read a program or data stored in a recording medium 1800 and provide the program or data to the CPU 1100 via the RAM 1200. The CPU 1100 may load the program from the recording medium 1800 onto the RAM 1200 via the media interface 1700 and execute the program loaded. The recording medium 1800 may be, for example: an optical recording medium, such as a digital versatile disc (DVD) or a phase change rewritable disk (PD); a magnetooptical recording medium, such as a magneto-optical disk (MO); a tape medium; a magnetic recording medium; or a semiconductor memory.

For example, in a case where the computer 1000 functions as the determination apparatus 200 according to an embodiment, the CPU 1100 of the computer 1000 may implement functions of the control unit 230 by executing programs loaded onto the RAM 1200. Furthermore, data in the storage unit 120 may be stored in the HDD 1400. The CPU 1100 may read these programs from the recording medium 1800 and execute the read programs. The CPU 1100 may obtain these programs from another device via the communication network 50.

### Others

Furthermore, the components of each apparatus/device in the drawings have been illustrated functionally and conceptually, and are not necessarily physically configured as illustrated in the drawings. That is, specific forms of separation and integration of each apparatus/device are not limited only to the one illustrated in the drawings, and all or part of the apparatus/device may be configured to be functionally or physically separated or integrated in any units according to various loads and use situations.

For example, in a case where plural terminal devices 10-x are included in any of the above described embodiments, the plural terminal devices 10-x may be devices that are different from one another. That is, as long as the plural terminal devices 10-x are capable of implementing their own functions, they are not necessarily the same devices. For example, depending on the situation where the terminal devices 10-x are installed or mounted, the shapes of the devices and functions the devices have may be different from one another.

Embodiments of the present application have been described in detail on the basis of some drawings, but these are just examples, and the present invention may be implemented in any other mode, to which various modifications and improvements have been made on the basis of the modes described in the disclosure of the invention section and knowledge of those skilled in the art.

Furthermore, any ‘section’, ‘module’, or ‘unit’ described above may be read as a ‘means’ or ‘circuit’, for example. For example, a determination unit may be read as a determination means or a determination circuit.

### REFERENCE SIGNS LIST

1 ROUTE DETERMINATION SYSTEM
10 TERMINAL DEVICE
13a RECEIVING UNIT
13b ROUGH POSITION CALCULATION UNIT
13c OBTAINMENT UNIT
13d SELECTION UNIT
13e CORRECTION UNIT
13f TRANSMISSION UNIT
30 BASE STATION
60 MOBILE DEVICE (MOBILE OBJECT)
63a CORRECTED POSITION INFORMATION OBTAINMENT UNIT
63b ROUTE INFORMATION OBTAINMENT UNIT
63c MOVEMENT CONTROL UNIT
100 CALCULATION APPARATUS
131 RECEIVING UNIT
132 GENERATION UNIT
133 TRANSMISSION UNIT
200 DETERMINATION APPARATUS
231 CORRECTED POSITION INFORMATION OBTAINMENT UNIT
232 RECEPTION UNIT
233 DETERMINATION UNIT
234 INSTRUCTION UNIT
235 OUTPUT UNIT

1. A route determination system including: terminal devices serving as references for a route of a mobile object; and a determination apparatus, wherein
the terminal devices have:
an obtainment unit that obtains correction information generated on the basis of data received from an artificial satellite; and
a calculation unit that calculates position information on the terminal device on the basis of the correction information obtained by the obtainment unit, and
the determination apparatus has a determination unit that determines a movement route for the mobile object on the basis of the position information calculated by the calculation unit.

2. The route determination system according to claim 1, wherein
the obtainment unit obtains, as the correction information, on the basis of data received from a plurality of the artificial satellites, correction information generated for each of the artificial satellites, and
the calculation unit calculates position information on the terminal device on the basis of the correction information generated for each of the artificial satellites.

3. The route determination system according to claim 2, wherein
each of the terminal devices further has a selection unit that selects, from the correction information generated for each of the artificial satellites, correction information corresponding to an artificial satellite that is able to be detected from a position of the terminal device, the artificial satellite being one of the artificial satellites, and
the calculation unit calculates the position information on the terminal device on the basis of the correction information selected by the selection unit.

4. The route determination system according to claim 3, wherein the calculation unit calculates the position information on the terminal device by the Precise Point Positioning (PPP) position determination calculation using the correction information selected by the selection unit.

5. The route determination system according to claim 1, wherein the obtainment unit obtains, as the data received from the artificial satellite: data received without the data being received via any base station; and data received via a base station.

6. The route determination system according to claim 5, wherein
the obtainment unit obtains, as the correction information, correction information generated for each of predetermined areas, on the basis of the data received without the data being received via any base station and the data received via the base station, and
the calculation unit calculates the position information on the terminal device on the basis of the correction information generated for each of the predetermined areas.

7. The route determination system according to claim 6, wherein
each of the terminal devices further has a selection unit that selects correction information corresponding to a position of the terminal device, from the correction information generated for each of the predetermined areas, the position being in the predetermined areas, and
the calculation unit calculates the position information on the terminal device on the basis of the correction information selected by the selection unit.

8. The route determination system according to claim 7, wherein the calculation unit calculates the position information on the terminal device by the Precise Point Positioning (PPP)-Real Time Kinematic (RTK) position determination calculation using the correction information selected by the selection unit.

9. The route determination system according to claim 1, further including:
a predetermined calculation apparatus, wherein
the obtainment unit obtains, as the correction information, correction information generated by the predetermined calculation apparatus.

10. The route determination system according to claim 9, wherein the obtainment unit obtains, as the correction information, correction information transmitted from the calculation apparatus via an artificial satellite.

11. The route determination system according to claim 1, wherein
the determination apparatus further has a reception unit that receives definition information defining the movement route, from a user, and
the determination unit determines the movement route for the mobile object on the basis of the position information calculated by the calculation unit and the definition information received by the reception unit.

12. The route determination system according to claim 11, wherein
the reception unit receives, as the definition information, definition information defining a mode of movement with reference to the terminal devices using a predetermined condition, from the user, and
on the basis of the definition information, the determination unit determines, as the movement route for the mobile object, a route including a relative position with reference to a position indicated by the position information calculated by the calculation unit, the relative position satisfying the definition information.

13. The route determination system according to claim 12, wherein
the reception unit receives the definition information defining the mode of movement using the predetermined condition, with a predetermined terminal device being a target to be used, the predetermined terminal device being one of the terminal devices, the movement being to a target point with reference to a position of the predetermined terminal device, the target point being where the mobile object is caused to arrive, and
in a case where the definition information defining the mode of the movement to the target point is received, the determination unit determines, as the movement route for the mobile object from the predetermined terminal device to the target point, a route including a relative position with reference to a position indicated by position information on the predetermined terminal device, the position information being of the position information calculated by the calculation unit, the relative position satisfying the definition information.

14. The route determination system according to claim 13, wherein in a case where definition information has been received, the definition information defining, using the predetermined condition, a mode of movement to a target point where the mobile object is caused to arrive, the target point being with reference to a position of a predetermined one terminal device of the terminal devices, with the predetermined one terminal device being a target to be used, the determination unit determines, as the movement route for the mobile object to the target point, a route including a relative position with reference to a position indicated by position information on the predetermined one terminal device, the relative position satisfying the definition information, the position information being of the position information calculated by the calculation unit.

15. The route determination system according to claim 13, wherein the determination unit calculates, as a position of the target point, a relative position with reference to the position indicated by the position information on the terminal device to be used, the relative position satisfying the definition information, and determines, as the movement route for the mobile object, a path through which the mobile object is caused to move to a target that is the calculated position.

16. The route determination system according to claim 13, wherein in a case where predetermined two terminal devices of the terminal devices are to be used and definition information has been received, the definition information defining, using the predetermined condition, a mode of movement from a start point to an arrival point, the start point being with reference to a position of one of the predetermined two terminal devices and being where the mobile object is cause to start movement to a target where the mobile object is supposed to arrive, the arrival point being with reference to a position of the other one of the predetermined two terminal devices and being where the mobile object is caused to arrive, the determination unit determines, as the movement route for the mobile object from the start point to the arrival point, a route including a relative position with reference to a position indicated by position information on each of the predetermined two terminal devices, the relative position satisfying the definition information, the position information being of the position information calculated by the calculation unit.

17. The route determination system according to claim 13, wherein
with a predetermined terminal device being a target to be used, the predetermined terminal device being one of the terminal devices, the reception unit receives definition information defining, using the predetermined condition, vertex points with reference to a position of the predetermined terminal device, and
in a case where the definition information defining the vertex points has been received, the determination unit generates a planar area having vertex points at relative positions with reference to a position indicated by position information on the predetermined terminal device, the relative positions satisfying the definition information, the position information being of the position information calculated by the calculation unit, and thereby determines the movement route for the mobile object on the basis of the planar area generated and the mode of movement indicated by the predetermined condition.

18.-19. (canceled)

20. The route determination system according to claim 13, wherein
in a state where at least two predetermined terminal devices of the terminal devices are to be used, the reception unit receives definition information defining, using the predetermined condition, vertex points with reference to positions of the two predetermined terminal devices, and
in a case where the definition information defining the vertex points has been received, the determination unit generates a three-dimensional area having a side surface that is a planar area having vertex points at relative positions with reference to positions indicated by position information on the two predetermined terminal devices, the relative positions satisfying the definition information, the position information being of the position information calculated by the calculation unit, and thereby determines the movement route for the mobile object on the basis of the three-dimensional area generated and the mode of movement indicated by the predetermined condition.

21.-24. (canceled)

25. A route determination method executed by a route determination system including a terminal device and determination apparatus, the terminal device serving as a reference of a route for a mobile object, the route determination method including:
an obtainment process in which the terminal device obtains correction information generated on the basis of data received from an artificial satellite, and a calculation process in which the terminal device calculates position information on the terminal device on the basis of the correction information obtained through the obtainment process; and
a determination process in which the determination apparatus determines a movement route for the mobile object on the basis of the position information calculated through the calculation process.

26. (canceled)
